(19) United States
(12) Patent Application Publication
(10) Pub. No.: US 2026/0247283 A1
(43) Pub. Date: Aug. 20, 2026

(54) METHODS, APPARATUSES AND SYSTEMS FOR NETWORK PACKET DIFFERENTIATION

(71) Applicant: InterDigital Patent Holdings, Inc., Wilmington, DE (US)

(72) Inventors: Ayesha Ijaz, Guildford (GB); Pascal Adjakple, Great Neck, NY (US); Ghyslain Pelletier, Montreal (CA); Justin Cray, Philadelphia, PA (US); Ahmed Almradi, Ipswich (GB); Martino Freda, Laval (CA); Benoit Pelletier, Roxboro (CA); Faris Alfarhan, Montreal (CA); Joe Huang, Montville, NJ (US)

(21) Appl. No.: 19/053,827

(22) Filed: Feb. 14, 2025

(51) Int. Cl. H04W 52/02; H04W 28/06

(52) U.S. Cl. CPC H04W 52/0225; H04W 28/06

(57) ABSTRACT

Procedures, methods, apparatuses, systems, devices, and computer program products for packet differentiation in a network. A wireless transmit/receive unit in the network receives from the network a grant for uplink transmission, receives a data packet, determines at least one characteristic of the data packet, determines, based on the at least one characteristic of the data packet, a value indicative of possible energy consumption associated with transfer of the data packet, and, based on the value indicative of possible energy consumption associated with transfer of the data packet and a given energy budget value, transmits the data packet to the network using the uplink grant or drops the data packet.

### TECHNICAL FIELD

The present disclosure is generally directed to the fields of communications, software and encoding, including, for example, to methods, apparatuses, systems directed to packet differentiation in a network.

### SUMMARY

In a first aspect, the present principles are directed to a method at a wireless transmit/receive unit, WTRU, the method including receiving from the network a grant for uplink transmission, receiving a data packet, determining at least one characteristic of the data packet, determining, based on the at least one characteristic of the data packet, a value indicative of possible energy consumption associated with transfer of the data packet, and based on the value indicative of possible energy consumption associated with transfer of the data packet and a given energy budget value, transmitting the data packet to the network using the uplink grant or dropping the data packet.

In embodiments, the method includes transmitting, to the network, information indicative of energy-related capabilities of the WTRU, and implementing a configuration based on the transmitted information. The energy-related capabilities can include at least one of energy capacity, energy consumption efficiency capability, and maximum transmission power. The configuration can include at least one of energy consumption budget per specific time period, a mapping between modality or type of data in a packet and value indicative of possible energy consumption associated with transfer of the data packet, a mapping between value indicative of possible energy consumption associated with transfer of the data packet and configurations of protocol layers, and attributes and/or weights for attributes for a utility function. The value indicative of possible energy consumption associated with transfer of the data packet can be determined as a function of the mapping between the modality or type of data in the data packet and the value indicative of possible energy consumption associated with transfer of the data packet.

In embodiments, the method includes monitoring energy consumption. The energy consumption can be monitored for a given time period. The data packet can be transmitted to the network in case the monitored energy consumption is below a configured value in a given time period. The data packet can be dropped in case the monitored energy consumption is above a configured value.

In a second aspect, the present principles are directed to a wireless transmit/receive unit, WTRU, comprising at least one processor configured to receive from a network a grant for uplink transmission, receive a data packet, determine at least one characteristic of the data packet, determine, based on the at least one characteristic of the data packet, a value indicative of possible energy consumption associated with transfer of the data packet, and, based on the value indicative of possible energy consumption associated with transfer of the data packet and a given energy budget value, transmit the data packet to the network using the uplink grant or drop the data packet.

In embodiments, the at least one processor is configured to transmit, to the network, information indicative of energy-related capabilities of the WTRU, and implement a configuration based on the transmitted information. The energy-related capabilities can include at least one of energy capacity, energy consumption efficiency capability, and maximum transmission power. The configuration can include at least one of energy consumption budget per specific time period, a mapping between modality or type of data in a packet and a value indicative of possible energy consumption associated with transfer of the data packet, a mapping between value indicative of possible energy consumption associated with transfer of the data packet and configurations of protocol layers, and attributes and/or weights for attributes for a utility function.

In embodiments, the at least one processor is configured to determine the value indicative of possible energy consumption associated with transfer of the data packet as a function of the mapping between modality or type of data in the data packet and the value indicative of possible energy consumption associated with transfer of the data packet.

In embodiments, the at least one processor is configured to monitor energy consumption. The at least one processor can be configured to monitor the energy consumption for a given time period. The at least one processor can be configured to transmit the data packet to the network in case the monitored energy consumption is below a configured value in a given time period. The at least one processor can be configured to drop the data packet in case the monitored energy consumption is above a configured value.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example conventional Quality of Service (QoS) framework;

FIG. 3 illustrates how the inter-play between device, network and application is believed to evolve;

FIG. 4 illustrates an example embodiment of a method at a UE;

FIG. 5 illustrates a first embodiment of an architecture according to the present principles;

FIG. 6 illustrates a second embodiment of an architecture according to the present principles;

FIG. 7 illustrates a method according to a further embodiment of the present principles; and

FIG. 8 illustrates a method according to a further embodiment of the present principles.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

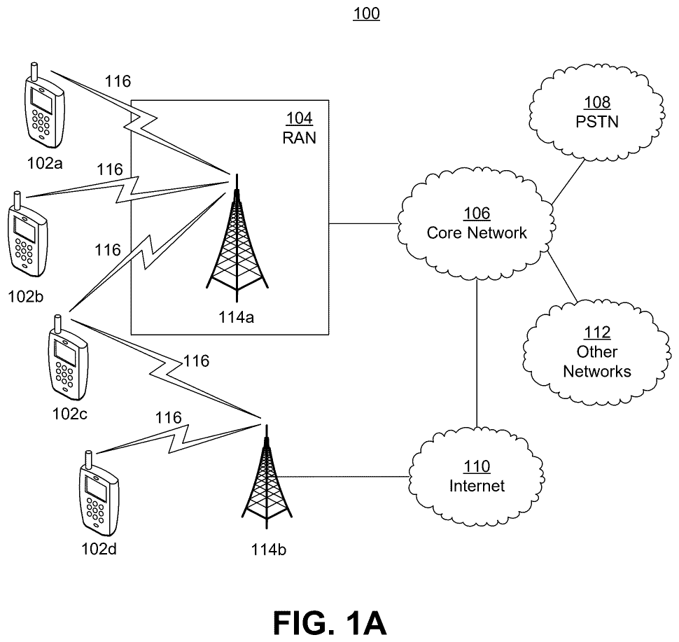

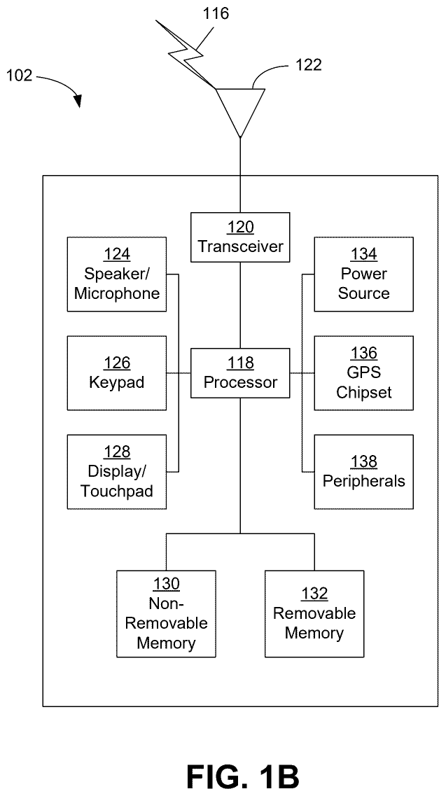

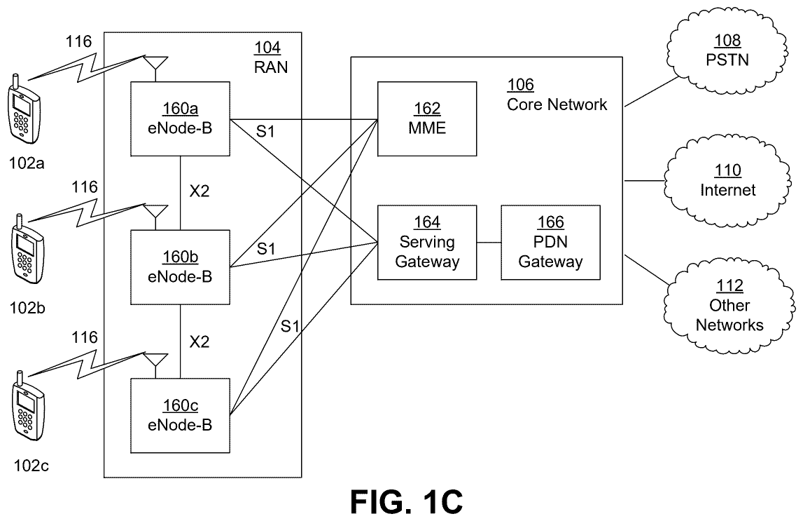

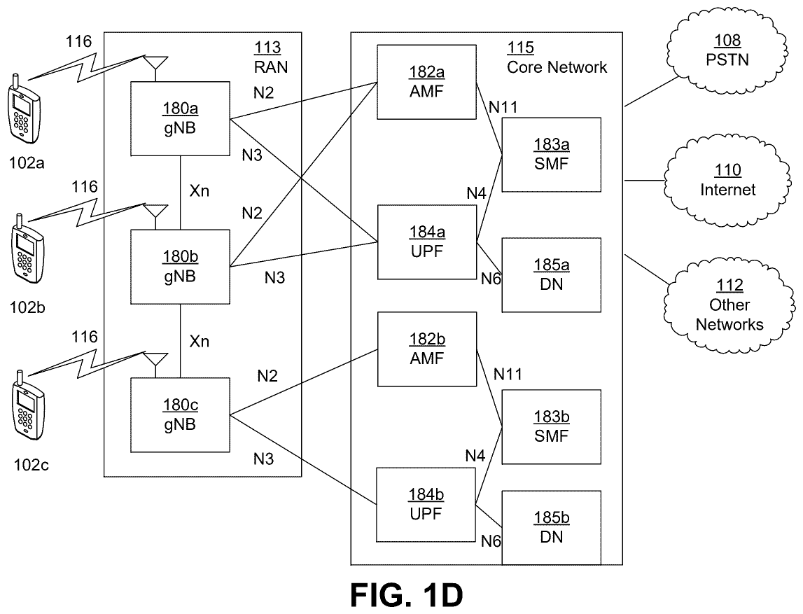

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire (i.e. obtain) location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In cellular communication, multi-attribute utility theory (MAUT) is a decision-making method used to evaluate and rank different configurations of protocol layers/functions for packet processing in the UE or in the network, based on multiple quality-of-service (QoS) attributes, like data rate, latency, coverage, and reliability, by assigning weights to each attribute according to their relative importance to the user, allowing for a comprehensive comparison of different network choices based on individual preferences and priorities. Unlike single-attribute decision making, MAUT considers various QoS parameters simultaneously, allowing for a more holistic evaluation of network performance. By combining the utility values of each attribute based on their weights, MAUT generates an overall utility score for a given configuration, enabling comparison and selection of the most preferred option. For example, MAUT may be used to select configuration of data processing methods across different protocol layers and/or to allocate network resources (e.g., power, time-frequency domain resources) among different users or services of the same user based on the corresponding individual QoS requirements. To illustrate MAUT, Table 1 illustrates an example of the use of a multi-attribute function for the selection of a car with Brand 4 as the selected car. In this example the attribute scores are normalized within a [0, 1] interval value range.

TABLE 1
Example of a car selection with a multi-attribute utility function.

| | | | | | Score (U = | |
|---|---|---|---|---|---|---|
| Attribute | Accel | Comfort | Price | MPG | Σᵢ₌₁ⁿ kᵢUᵢ) | Rank |
| Weight | 0.3 | 0.2 | 0.4 | 0.1 | K = 1 (sum | |
| | | | | | of weights) | |
| Brand 1 | 0.25 | 0.85 | 0.6 | 0.4 | 0.525 | 2 |
| Brand 2 | 0.7 | 1 | 0.1 | 0.05 | 0.455 | 4 |
| Brand 3 | 0.05 | 0.35 | 0.9 | 0.5 | 0.495 | 3 |
| Brand 4 | 0.15 | 0.75 | 0.7 | 0.7 | 0.545 | 1 |

It will be understood that, in a network, attributes with weights may be used to differentiate packet treatment. In other words, data transport procedures over wireless interfaces may typically make use of a number of QoS attributes related to the data transfer requirements of an associated service such as prioritized bit rate (PBR), packet delay budget (PDB), packet error rate (PER) and/or relative priority of the concerned (possibly aggregated) service(s) e.g., using specific prioritization algorithms based on queuing theory, based on parametrized functions (e.g., Logical Channel Prioritization—LCP and/or transport block multiplexing in 4G/LTE and 5G/NR MAC protocol layers) and/or weighted functions to apply differentiation between protocol data units (PDU) e.g., data units including IP packets.

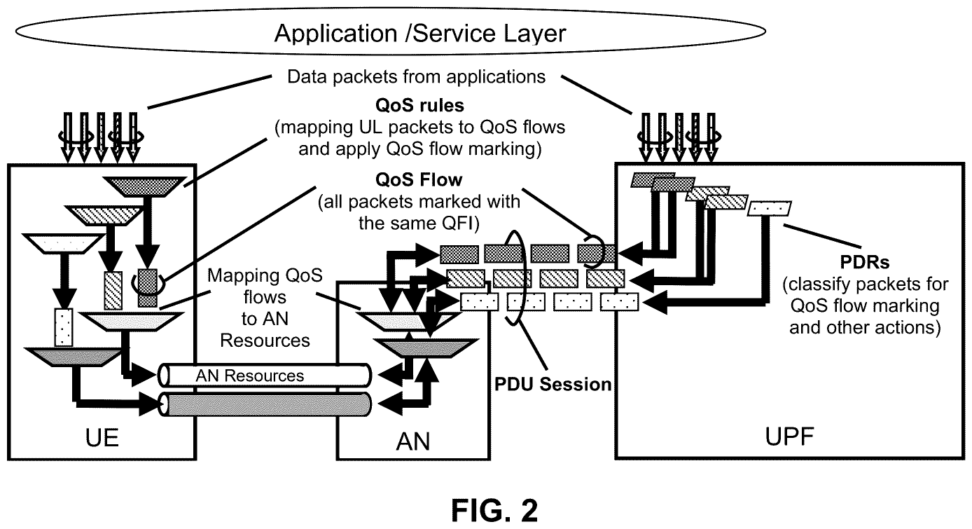

FIG. 2 illustrates an example conventional Quality of Service (QoS) framework. The figure shows a conventional principle for classification and User Plane marking for QoS flows and mapping to Access Network (AN) resources. In the framework, the quality of experience is evaluated on the basis of a single attribute (e.g. connectivity) relative to one or more QoS parameters/metrics such as delay, throughput, and reliability. In this framework, the typical utility function for network data transfer optimization is data transfer rate (i.e. ratio of data transferred/transfer time) subject to constraints such as latency, packet loss, and bandwidth availability. The current NR specification does not support information value-based per-packet differentiation. Differentiated packet treatment is rather based on a framework wherein the principle for classification and user plane marking for QoS flows, and mapping to access network resources use PDF sets, QoS rules, and PDR rules based on filter parameters (IP packet filters or ethernet packet filters) other than information value. The mapping of packets to access network packet processing procedures and transmission resources are specified at the granularity of QoS flow, not at the per-packet level granularity. The mapping principle was subsequently enhanced to support limited differentiated PDU set handling but nothing native to the QoS framework. Packet classification is still not based on packet information value, but rather on parameters such as ports, flow label, security parameter index, protocol ID of the application (application type), user type or subscription, source/destination MAC or IP addresses, EtherType, customer-VLAN tag, and other attributes related to traditional data transfer etc., depending on whether it is an IP packet or ethernet packet.

However, given communication network evolution, user plane data transfer in future cellular systems is expected to support enhanced connectivity capabilities (compared to current 5G systems) as well as new information service-related capabilities (e.g. energy resource as a service, computing as a service, AI/ML as a service, and sensing as a service) for a diverse set of devices and a diverse set of emerging services such as extended reality (XR), brain-computer interface (BCI), connected autonomy and machine-to-machine (M2M) communications, holographic societies, and the metaverse. Further, communication as pure connectivity service is evolving from connectivity-based service to connectivity service plus information service with the proliferation of high-resolution sensors into handset, vehicles, robots, IOT devices and extension in modalities (e.g., ISAC, lidar, etc.), and the continuous increase in access network (last mile) capacity (Gbps). These trends are believed to a) enable ability for a cost-effective, high-fidelity instrumentation of the physical world (digital twins, metaverse, immersive reality), b) accelerate the use of AI/ML methods in communication taking advantage of the availability of plethora of data, and c) require an unprecedented increase of the role of computation, allocation of energy and data storage.

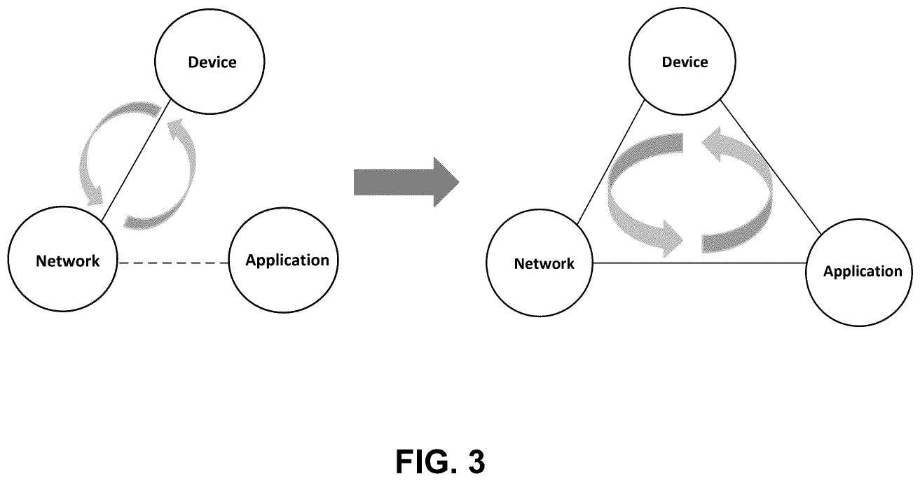

FIG. 3 illustrates how the inter-play between device, network and application is believed to evolve, with the user plane evolving from currently supporting connectivity driven requirements (as shown to the left) to supporting a broader set of requirements and new data types from applications for computing as a service, AI/ML as a service, sensing as a service, etc. (as shown to the right).

The conventional interplay (to the left) has the device and the network collaborate within a framework of a static protocol behavior and offline mapping of QoE to QoS parameters, while the network and the application interacts through a static offline mapping of QoE SLA to QoS system performance parameters, and there typically is no direct interaction between the device and the application. In other words, it can be said that the user experience is driven by the protocol behavior.

In future interplay (to the right), the device, the network and the application can interact with each other which can enable a protocol behavior driven by user experience. For example, the device can handle and provide information about device capabilities (e.g. battery level, processing power (nominal, actual), memory/storage (nominal, actual), privacy/security capabilities, number and types of application running, and thermal conditions), about AI data, algorithms, models and parameters, and about device state; the network can handle and provide information about communication resources, computing resources, memory and storage resources, energy resources, privacy/security capabilities, QoS system performance parameters, and AI data, algorithms, models and parameters; and the application can handle and provide information about user experience attributes (e.g. intent, meaning, context, significance, value of information, and subjective satisfaction level, in other words, application data features), and AI data, algorithms, models and parameters.

This evolution can require a new look at the current user plane interface in terms of both the conventional user plane interface and conventional QoE/QoS framework to support the new requirements of connectivity service capabilities and the requirements of the new information service capabilities. The evolved interplay is also suitable for flexible and adaptive network protocol behaviors as a function of the QoE, potentially a new data plane in support of transfer of data consumed by the new information services provided by the network, support for elastic QoS/QoE, as well as qualitative/information value-based communications, wherein the information value may reflect the contribution of the information to the desired outcome (at the receiver and from the application perspective) in terms of user experience.

It will thus be appreciated that there is a need for solutions that help extend PDU differentiation techniques beyond attributes related to data transfer, for example using additional attributes as part of existing algorithms and/or by applying a function that determines an Information Value (IV) for data units. Such solutions can include defining new attributes in support of multi-attributes QoE solutions, performing packet classification as a function of packet information value, and performing differentiated treatment on per packet basis or on per group of packets basis throughout interface protocols between a transmitter/source and a receiver/destination based on packet information value.

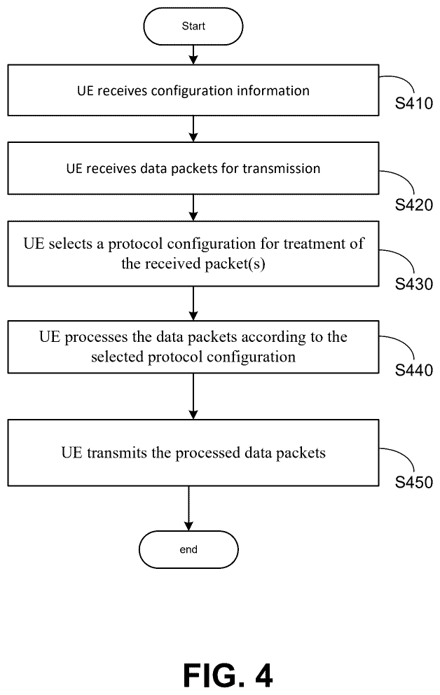

FIG. 4 illustrates, briefly (with details to follow), an example embodiment of a method at a UE.

In step S410, the UE receives information indicative of one or more protocol configurations (e.g. ciphering or integrity protection, error protection, data multiplexing etc.) for packet treatment, information indicative of one or more configurations for determination of packet information value (that will be explained herein) of a packet, e.g. associations between different packet characteristics and packet information values, information indicative of one or more configurations for association between protocol configurations and packet information values, and information indicative of a configuration for evaluation of QoE utility, wherein QoE utility may be a function of one or more attributes e.g. energy and/or storage cost, computing efficiency, inference accuracy etc.

In step S420, the UE receives data packets for transmission in its buffer. The UE determines the respective packet characteristics of each packet based on, for example, the content of the packet (e.g. heading), the size of the packet, identifiers associated with the packets and indicated in a header or via the application, etc. The UE also determines the respective packet information value (IV) based on at least the determined packet characteristics and its configuration (e.g. based on the configuration for determination of packet information value and/or the configuration for evaluation of QoE utility).

In step S430, the UE selects a protocol configuration for treatment of the received packet according to the determined packet information value and one or more of its configurations (e.g. the configuration for association between protocol configurations and packet information values).

In step S440, the UE processes the data packets according to the selected protocol configuration.

In step S450, the UE transmits the processed data packets.

As will be appreciated, the present principles can support QoE-aware packet treatment wherein differentiated packet processing configurations can be applied to maximize the QoE utility that is a function of key system, device or operator performance requirements. For example, when a system is congested or when data should be discarded, additional differentiation may be used to prioritize, differentiate the treatment of various data units (e.g., to prioritize transmission of data units that can improve QoE utility).

### Definitions and Terminology

Quality of Service (QoS) impacts the transfer of data units for a given service. QoS is the collective effect of service performances which determine the degree of satisfaction of a user of the service. It can be measured in terms of parameters, i.e. performance metrics, that can be directly observed and measured at the point at which the service (e.g. network service, device service, application service, etc.) is accessed by the user.

Quality of Experience (QoE) impacts the overall end-user experience. QoE is the overall acceptability of an application or service, as perceived subjectively by the end-user. Its measurement includes the complete end-to-end system effects e.g. device, network, application, etc., quantifiable in terms of QoS performance metrics, and the subjective measurement as perceived by the user e.g. mean opinion score.

A “QoE utility function” may be conceptualized to include quality-of-human-experience and quality-of-machine experience. Herein, quality-of-human-experience relates to the collective effect of service performances which determine the degree of satisfaction of a user of the service as subjectively determined by the user based on its expectation and context, and quality-of-machine experience relates to the impact of involvement of machine and machine intelligence whether it is in the network, device or application to the end user quality of experience. The utility function of a QoE may be modelled to integrate a) the evaluation of QoS i.e. the objective/quantitative evaluation (see Table 2) of the QoE related to the performance of the network, the device and the application, and b) the subjective evaluation of the QoE as perceived by the user and influenced by factors such as user's expectation, emotion, mood, context, location, and other psychosomatics factors. In the context of communication service beyond simple connectivity service, the quantitative part of a Quality of Experience (QoE) utility function may be evaluated from the perspective of one or more dimensions, e.g. performance, cost, safety, security, privacy, and system autonomy. For any of these dimensions, the attributes of a QoE multi-attribute utility function may include one or more of connectivity performance metric (e.g. data rate including non-GBR, GBR, delay-critical GBR/maximum data burst, latency, jitter), computing efficiency performance metric, energy efficiency performance metric (e.g. device power consumption efficiency, network energy consumption efficiency), AI/ML efficiency performance metric, sensing efficiency performance metric. A requirement for QoE/QoS in terms of key performance indicators (KPI) may be expressed in term of the metrics of the attributes of the utility functions.

A QoE utility function as defined herein may be expressed as

$$U = {\sum }_{i = 1}^{n} {k}_{i} {U}_{i} + α H ,$$

where Uᵢ is the score/utility of utility attribute i, kᵢ is the weight of the score of utility attribute i, α is the weight of the subjective evaluation H of the QoE. αH may be expressed as

$$α H = {\sum }_{i = 1}^{n} {∝}_{i} {H}_{i} ,$$

where ∝ᵢ is the weight of the subjective evaluation of the utility attribute i, and Hᵢ is the subjective evaluation of the utility attribute i.

In its simplest form, a QoE utility function may be a function that dynamically optimizes the provision of QoS within a range of possible QoS values for one or more of its attributes, possibly across different QoS-level each corresponding to a different, yet subjectively acceptable QoE.

The “information value (IV)” of a packet is the contribution (i.e. impact) of the packet to the quality of experience as measured by the QoE utility function. In other words, it is a measure for the application perspective of how the packet affects the desired outcome in terms of user experience as perceived by the user. The information value of a packet may be seen as the derivative of the QoE utility function relative to the packet. Similar to the QoE utility function, the information value of a packet may be expressed in terms of one or more of the attributes of the QoE utility function.

Packet information value may be quantized into a range of discrete values. Packets of the same information value may be assigned different importance/priority, or a supplemental information value for tiebreaking in differentiated treatment.

Herein, the term information value may be used in reference to a quantized value (e.g. integer number, real number, enumerate e.g. bad, good, low, medium, high), an index of an information value, and an identifier (ID) of an information value.

Mapping/Maps, e.g. “mapping a first thing to a second thing”, “mapping between a first thing and a second thing”, or “maps a first thing to a second thing”: these terms are used herein to mean association between a first thing and second thing, associating a first thing to second thing or associating a second thing to a first thing, or associates a first thing to a second thing, or associates a second thing to a first thing. These expressions may be used interchangeably in conjugation tense. For example: a) a first thing maybe an information value and second thing may be QoS flow or vice versa; b) a first thing may be an information value and a second thing may be a configuration or vice-versa; c) a first thing may be a packet and a second thing may be a protocol layer (e.g. lower layer protocol, next protocol in the packet processing path) or vice versa (in which case mapping/maps/association/associates is used to mean routing of the packet to the protocol layer); d) a first thing may be a packet, and a second thing may be protocol function within a protocol layer, or vice versa (in which case mapping/maps/association/associates is used to mean processing of the packet with the protocol function).

“Packet marking” is the action of associating a packet with something (that may be a plurality of things). For example, a packet may be associated with one or more of an information value, a QOS Flow ID, etc. A UE may signal a marking of a packet from a first protocol layer or protocol function to a second protocol layer of protocol function through a service access point (SAP) or an application interface (API) between the first protocol layer or protocol function and the second protocol layer of protocol function. Alternatively, a UE may signal a marking of a packet, from a first protocol layer or protocol function to a second protocol layer of protocol function, or a UE may signal a marking of a packet to a receiver (e.g. a network node) by including the packet marking into the packet header.

“Computing processing efficiency” is a measure of how much work a computer can do in a given amount of time and/or power. It is important for developing cost-effective algorithms and systems that can handle large amounts of data. It can measure computing power (i.e. the ability of a computer to process data and produce results), energy consumption (i.e. the amount of energy used by a computer's hardware and network devices), and performance per power units (e.g. watt i.e. the rate of computation per watt of power consumed).

“Normalized computing processing capability” is a standardized measure of a computer system's processing power, where the raw processing speed is adjusted to account for factors like clock speed, architecture, and other variables, thus allowing for a fair comparison between different systems, even if they have different hardware configurations. Essentially, it is a way to put computing power on a common scale to facilitate meaningful comparisons.

“Normalized computing processing power consumption” is a measure of how much power a computer system uses per unit of computational work performed (e.g. number of watt/GFLOPS), essentially allowing for a direct comparison between different systems regardless of their raw processing power, by dividing the total power consumption by a standardized performance metric like FLOPS (floating-point operations per second) or similar benchmarks.

Various resources can affect QoS and thereby QoE. In the context of communication network evolution, the budget of resources under the control of the network and the UE affecting QoE account for more than just connectivity attributes of QoE. It accounts for the dimensions of QoE attributes for, for example, connectivity resources, computing resources, energy resources, AI/ML resources and sensing resources. Table 2 provides examples of resources that, in a sense, represent knobs for the controls of QoS and thereby QoE.

TABLE 2
Example of QOS evaluation attributes and corresponding
utility function metrics and resource metrics

| Attributes | Utility function metrics | Resource metrics |
|---|---|---|
| Connectivity | data rate including non- | Time-frequency domain resources (GBR, |
| | GBR, GBR, delay-critical | non-GBR delay-critical), transmission |
| | GBR/maximum data burst, | power, number of transmission and |
| | latency e.g. packet delay | reception points (TRPs) |
| | budget, jitter, packet error | |
| | rate, number of bits/Hz | |
| Computing | Computing processing | Normalized computing processing power |
| | efficiency e.g. number of | or capability e.g. number of FLOPS, |
| | bits/flops, Computational | number of cores, speed (GHz), and cache |
| | accuracy, | memory of a CPU, number of CPU, |
| | duration/processing delay, | number of GPU or NPUs, number of TPUs |
| | meeting or not meeting | |
| | computing processing power | |
| | budget for a time period | |
| Energy (NW, | Energy consumption | Normalized energy resources (for example |
| device) | efficiency e.g. number of | “current intensity-time” domain resources |
| | bits/joules, number of | e.g. number of Ah, number of Wh), energy |
| | bits/joule/Hz, number of | source type, e.g. renewable energy versus |
| | bits/watt, number of | fossil energy |
| | watts/flops, ratio of | |
| | renewable energy (e.g. | |
| | harvested energy) to energy | |
| | capacity or total energy | |
| | consumption, ratio of carbon | |
| | emission to energy | |
| | consumption, energy | |
| | consumption (e.g. energy | |
| | credit consumed) per | |
| | specific operation/task, | |
| | meeting or not meeting | |
| | energy consumption budget | |
| | for a time period | |
| AI/ML (data, | Data efficiency, e.g. amount | Training data, monitoring data, |
| models/algorithms, | of data necessary for a | model/algorithm data, inference data |
| inference) | specified level of | |
| | performance | |
| | Time efficiency e.g. time to | Time domain resources, connectivity |
| | complete an inference task | metrics, compute metrics |
| | for a specified level of | |
| | performance, i.e. processing | |
| | delay | |
| | inference efficiency e.g. | Models/algorithms |
| | optimization target matching | |
| | degree | |
| | computing efficiency | See above |
| | energy consumption | See above |
| | efficiency | |
| | Storage efficiency | |
| Sensing | Sensing efficiency e.g. | Time-frequency domain resources, sensing |
| | sensing resolution | devices e.g. LiDAR sensors, camera |
| | | modules, handset, vehicles, robots, IoT |
| | | devices/actuators |
| Storage | Storage efficiency | Raw capacity versus usable capacity (e.g. |
| | | in MB or GB), data access time, read/write |
| | | speeds, etc. |
| Safety, security | Ciphering/integrity | ciphering/integrity protection algorithm |
| and privacy | resiliency, computational | types, quantum cryptography, symmetric |
| | efficiency, processing time | cryptography, asymmetric cryptography |
| | efficiency | |

A transmitter (i.e. source) can for example be a UE, a network node that can include one or more of a RAN access network node (e.g. base station), core network node (e.g. UPF), service network node (e.g. application server), etc.

A receiver (i.e. destination) can for example be a UE, a network node that can include one or more of a RAN access network node (e.g. base station), core network node (e.g. UPF), service network node (e.g. application server), etc.

A property of scheduling information (e.g., an uplink grant or a downlink assignment) may include of at least one of a frequency allocation, an aspect of time allocation (such as time instance and/or a time duration), a priority, a modulation and coding scheme, a transport block size, a number of spatial layers, a number of transport blocks to be carried, a Transmission Configuration Indication (TCI) state or Sounding Reference Signal Resource Indicator (SRI), a number of repetitions, whether the grant is a configured grant type 1 (i.e., UE immediately using the configured UL resources after receiving the configuration information), type 2 (i.e., UE waiting until an explicit MAC CE indication before using the configured UL resources) or a dynamic grant.

An indication by DCI (or simply an indication) may include of at least one of an explicit indication by a DCI field or RNTI used to mask CRC of the PDCCH, an implicit indication by a property such as DCI format, DCI size, Coreset or search space, aggregation level, identity of first control channel resource (e.g., index of first CCE) for a DCI, where the mapping between the property and the value may be signaled by RRC or MAC, and an explicit indication by a DL MAC CE.

Channel conditions can include any conditions relating to the state of the radio/channel, which may be determined by the UE from a UE measurement (e.g., L1/SINR/RSRP, CQI/MCS, channel occupancy, RSSI, power headroom, exposure headroom), L3/mobility-based measurements (e.g. RSRP, RSRQ, s-measure), a RLM state, and/or channel availability in unlicensed spectrum (e.g. whether the channel is occupied based on determination of an LBT procedure or whether the channel is deemed to have experienced a consistent LBT failure).

“Data type” may refer to one of user plane data, control plane data (e.g. SRB, NAS data), system data, sensing data, positioning data, model transfer data, computing/operational data, measurement data, data collected for model training purposes, or more generally data plane data.

“Packet/PDU” may describe the packet/PDU in any of Non-Access Stratum (NAS), Service Data Adaptation Protocol (SDAP), Packet Data Convergence Protocol (PDCP), Radio Link Control (RLC), Medium Access Control (MAC), Physical layer (PHY), and a newly defined layer, e.g. an upper layer in a data plane lying above the SDAP or PDCP. More generally, a protocol data unit (PDU) may be used to refer to any type of information processed by any given protocol, whereas a data unit that is input to a protocol layer and thereby not yet processed by said layer may be referred to as a Service Data Unit (SDU).

A PDU may be a data PDU or a control PDU.

The terms “packet” and “PDU” may be used interchangeably.

A “configuration” may refer to any parameter associated with a packet treatment in any protocol layer or protocol function (e.g. L1 configuration, L2 configuration, L3 configuration, etc.), which can be modified by a configuration function or procedure. Herein, the UE being “configured with” or “(pre)-configured with” may refer to the scenario that the UE receives configuration information and uses this to configure itself. The configuration information may be received from the base station or another node. In case the UE receives signalling including such configuration information, e.g., from a base station, the UE may receive one of more configuration aspects by dedicated signalling (e.g., RRC, or MAC) or by common/shared signalling (e.g., SIB) or L1/L2 signaling e.g., from a base station. In the case the UE receives configuration information from another node, this may for example be received e.g. via sidelink communication (e.g., PC5 RRC, PC5 NAS signaling), via Uu reference point NAS signaling (e.g. in the case another node is located in the core network), via application layer signaling (e.g. in the case another node is located in the service network), etc. The UE being “configured” or “(pre)-configured” to perform an action may also refer to the scenario that the UE is hard coded to perform the action e.g. via standard specifications.

Herein, the terms “device state”, “UE state”, “state of UE”, and “state of device” may be used interchangeably.

Herein, a “protocol function” may refer to one or more of the following packet processing functions, which will be described with reference to seven groups of functions.

A first group of functions is for the PHY and for example includes channel coding/decoding, rate matching, Modulation/demodulation, antenna and resource mapping/demapping.

A second group of functions is for the MAC and for example includes mapping between logical channels and transport channels to ensure proper data flow, multiplexing/demultiplexing in which the MAC sublayer combines or separates MAC Service Data Units (SDUs) from different logical channels into/from transport blocks (TBs) that are then delivered to/from the physical layer using transport channels, scheduling information reporting (including scheduling requests and buffer status reports), Hybrid Automatic Repeat Request (HARQ) that can enable error correction using (in the case of CA) a dedicated HARQ entity in each cell to handle retransmissions and ensure reliable data transmission, dynamic scheduling that manages prioritization of UE and allocates resources based on varying priorities to enhance overall system performance, logical channel prioritization in which logical channels within a UE are assigned priorities to determine their order of resource allocation and access to the available transmission resources, overlapping resources handling where the MAC sublayer efficiently manages overlapping resources including prioritization between dynamic grants, configured grants, and SR resources within a single UE, aiming for optimal utilization, padding and control elements in which the MAC sublayer, if necessary, adds padding bits to ensure proper alignment with the uplink grant size and the number of bits provided to the physical layer, after addition of all buffered data and triggered MAC control elements, and control of radio and/or related configuration aspects wherein MAC control signalling may modify, update or configure one or more radio aspects, possibly using pre-configured information elements configured by L3/RRC.

A third group of functions is for the RLC and includes ARQ retransmissions (Acknowledge Mode, AM), segmentation (AM and Unacknowledge Mode, UM) based on Transport Block Size (TBS) and size indicated by MAC (wherein RLC controls the timing of PDU construction and delivery to lower layers, which is determined based on the transmission time made available by MAC as a function of grant availability, latency of data, and TB construction time, and at such time, the RLC determines whether segmentation is required for a given SDU; a retransmitted segment can be segmented again and, assuming this type of retransmission is used instead of HARQ, the Tx entity needs to keep track of a “Segment tree” to recover a single PDU transmitted; and segmentation can be considered in other layers (e.g. in PDCP or MAC) in alternate designs), concatenation (AM and UM) sitting on top of MAC with the aim to save on LCID/SN bytes, header addition (AM and UM), including indication of sequence numbers, segment offset (SO), and segment information (SI) in case of segmentation (wherein sequencing can be considered as a redundant/induced functionality, e.g. when already done in PDCP), polling a corresponding entity (AM) for feedback for transmitted SDUs, asking for reception of status reports, reassembly of PDUs of a segmented SDU and delivery to upper layers (AM and UM) (maintenance of a Rx window and a timer for reassembly), discard of PDUs within an SDU that cannot be re-assembled due to loss (UM) (for example, if a PDU that is a segment of an RLC SDU is lost, the remaining PDUs of the same SDU can be discarded, as there is no possibility to retransmit a lost PDU), discard of duplicate PDUs (AM) (for example due to PDCP duplication or due to an unnecessary retransmission due to an ACK/NACK HARQ feedback error (which is a functionality can be performed in combination with PDCP in an embodiment), and delivery of an ACK/NACK status report per PDU (AM).

A fourth group of functions is for the PDCP and includes bearer management (e.g. data routing, split bearers, dual connectivity etc. that can be viewed as artificial bucketing of data), packet duplication and routing, discard of duplicates and outdated packets (duplication, FEC, duplicates resent due to HARQ NACK/ACK errors), integrity protection and ciphering, sequence numbering, reordering in/out of order delivery (e.g. lost packets come later, PDUs sent on multiple carriers arrive at different timelines), retransmissions (e.g. FEC, upon handover for unacknowledged PDUs, RRC re-establishment/RLF, and buffer management (i.e. control and determination of what data to generate, store, process or discard).

A fifth group of functions is for the SDAP and includes mapping of packets from the PDU layer or from in-RAN data plane application to lower layer protocol configuration.

A sixth group of functions is for the PDU layer and includes classification and marking of packets from upper layer.

A seventh group of functions is for the packet coding and includes packet processing (e.g. packet erasure correction coding that transforms X input packets into Y output packets, wherein a successful recovery (e.g. at the receiver) of the X input packets only requires reception of X output packets) and packet decoding.

In one architecture embodiment, the gNB can be in a combined CU and DU (no split). In another architecture embodiment, CU and DU may be split and some functions (e.g. PDCP high, SDAP, or core network functions) may be in the CU while other functions (e.g. RLC, PDCP low, MAC, PHY) may be at the DU. PDCP may also be at the DU in one architecture embodiment (e.g. to have a simple piece of equipment that does not have any layer 2). In another architecture embodiment, radio units (RUs) may be used and the gNB may be split over CU/DU/RU, where some functions (e.g. PHY, MAC, and/or RLC) may be located and managed at the RU.

In one architecture embodiment, the split between DU and RU may be in the mid-PHY layer (e.g. where upper PHY layer resides in the DU and lower PHY layer resides in the RU). In one architecture embodiment, the user plane and the data plane are terminated in different logical entities. Herein, a statement indicating a functional split may refer to a split anywhere in the CU/DU/RU at the transmit or the receive side of the protocol stack.

The following terms can be used herein in the context of functional splits from the network's perspective: C-Plane (Control Plane) refers specifically to real-time control between DU and RU, U-Plane (User Plane) refers to user generated data, sample data transferred between DU and RU, S-Plane (Synchronization Plane) refers to traffic between the RU or DU to a synchronization controller (synchronization controller messages), High-PHY wherein portions of the PHY processing, including FEC encode/decode, scrambling, and modulation/demodulation, are on the DU side of the fronthaul interface, and Low-PHY wherein portions of the PHY processing, including FFT/IFFT, digital beamforming, and PRACH extraction and filtering, are on the RU side of the fronthaul interface.

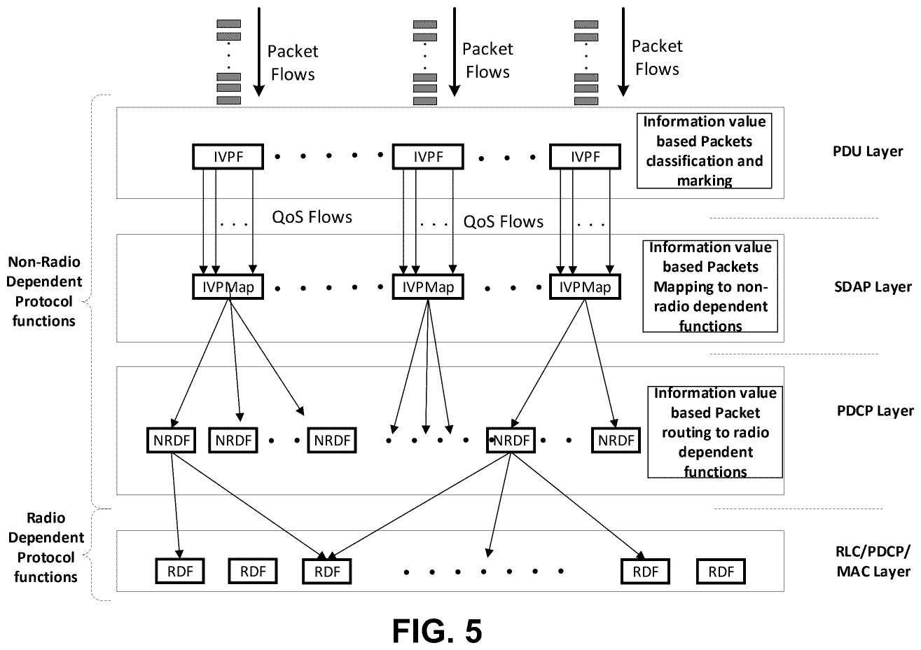

FIG. 5 illustrates a first embodiment of an architecture according to the present principles. The first embodiment is based on conventional architectures and adapts certain existing protocol layers. The conventional architecture can be a conventional 5G QoS/RB architecture in both core network (CN) and radio access network (RAN) with modifications made to certain protocol functions.

Possible new or modified functions of the Transport layer include transfer of cross Application-RAN interaction parameters to enable packet information value-based packet treatment, packet erasure control as a function of information value, AQM and congestion control as a function of packet information value, packet routing as a function of packet information value, packet segmentation as a function of packet information value, and packet multiplexing as a function of packet information value.

Possible new or modified functions of the PDU layer include packet information value-based packet classification, packet association to packet information value, packet segmentation as a function of packet information value,

Possible new or modified functions of the SDAP layer include packet marking with packet information value by including the packet information value into the packet header, packet marking with QoS Flow ID (instead of this being done in PDU layer i.e. layer above SDAP), packet information value-based packet classification e.g. for data plane with applications residing in RAN, packet routing (e.g. to DRB) as a function of the DRB and the DRB configuration.

Possible new or modified functions of the PDCP layer include that the UE may perform, on a packet, any of the PDCP functions described herein as a function of the information value of the packet, or as a function of the information value of the packet and a configuration received by the UE for processing the packet in PDCP.

Possible new or modified functions of the RLC include that the UE may perform, on a packet, any of the RLC functions described herein as a function of the information value of the packet, or as a function of the information value of the packet and a configuration received by the UE for processing the packet in RLC.

Possible new or modified functions of the MAC include that the UE may perform, on a packet, any of the MAC functions described herein as a function of the information value of the packet, or as a function of the information value of the packet and a configuration received by the UE for processing the packet in MAC.

Possible new or modified functions of the PHY include that the UE may perform, on a packet, any of the PHY functions described herein as a function of the information value of the packet, or as a function of the information value of the packet and a configuration received by the UE for processing the packet in PHY.

Possible new or modified functions of the XaaS Management/Control Plane include signaling/control of configuration of protocol layers/functions to enable information value-based packet treatment. This function may be a protocol function separate from the legacy control plane function (e.g. RRC, NAS) or may be a protocol function integrated into the legacy control plane. Treatment of a signaling packet in support of information value-based packet treatment may itself be a function of the information value of a packet that triggers the signaling.

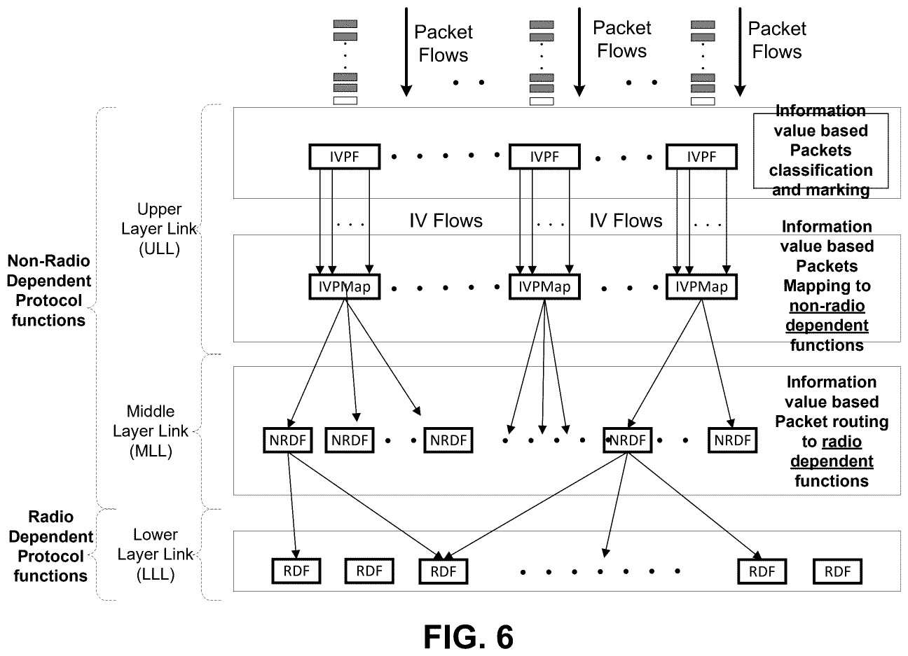

FIG. 6 illustrates a second embodiment of an architecture according to the present principles.

In the second embodiment, packet information value based differentiated treatment, as described herein, may be performed on data that may or may not be subject to the legacy QoS flow processes of the CN and/or to the legacy logical bearer assignment in RAN. Alternatively, such solutions may be applied within a single logical grouping of data information (e.g., a default bearer) and/or may be applied with non-optimized (e.g., default values) QoS configuration e.g., from the Core Network.

The UE is configured with one or more sets of protocol functions, wherein each set of protocol function may be structured as a plurality of components. For example, such a structure may include one or more of an upper layer link (ULL), a middle layer link (MLL) and lower layer link (LLL). The ULL and MLL may include non-radio dependent functions. The LLL may include radio dependent functions.

The protocol functions of the ULL, MLL, or LLL may be further sub-grouped into one or more protocol layers.

One ULL can be configured per application data session.

One or more MLL can be configured per application data session, with one MLL being configured per QoS differentiation granularity level e.g. information value.

One LLL can be configured per QoS differentiation granularity level e.g. information value.

ULL functions may for example include one or more of the fifth group of functions and sixth group of functions described herein. For example, packet classification as a function of packet information value, mapping between information value of a packet and a MLL, marking information value in packets may be performed in ULL. For example, packet classification as a function of its information value may be performed in the legacy PDU layer (i.e. NAS), and marking (e.g. association) information value in packets may be performed in the legacy PDU layer and/or legacy SDAP layer, or in an equivalent protocol layer in RAN.

The MLL may for example include one or more of the fourth group of functions, the third group of functions and the seventh group of functions described herein. MLL may exclude packet Segmentation function. The UE may perform, on a packet, any of the MLL functions described herein as a function of the information value of the packet, e.g. information value based selective out of order delivery, information value based reordering and in order delivery, information value based packet routing to lower layers, information value based selective packet duplication, information value based selective error correction through ARQ, information value based selective flexible packet coding (e.g. network coding of a packet as a function of the packet information value), and RLC mode (AM, UM, TM) selection as a function of a packet information value.

The LLL may for example include one or more of the first group of function, the second group of functions described herein, segmentation as a function of a packet information value, wherein logical channels are used to support differentiated treatment (e.g. prioritization) of packets: mapping between logical channel and transport channels, information values are used to support differentiated treatment (e.g. prioritization) of packets: mapping between information values and transport channels, logical channels are used to support multiplexing of packets from MLL to LLL or demultiplexing of packets from LLL to MLL (e.g. multiplexing of packets from one or different logical channels into transport blocks (TBs) to be delivered to the physical layer on transport channels, and demultiplexing of packets to one or different logical channels from transport blocks (TBs) delivered from the physical layer on transport channels), information values are used to support multiplexing of packets from MLL to LLL or demultiplexing of packets from LLL to MLL (e.g. multiplexing of packets having one or different information values into transport blocks (TBs) to be delivered to the physical layer on transport channels, and demultiplexing of packets have one or different information values from transport blocks (TBs) delivered from the physical layer on transport channels), information values based logical channel prioritization, information value-based uplink scheduling (if LCH is no longer used for differentiated treatment of packets) error correction through HARQ, information value-based scheduling information reporting (similar to BSR, DSR, SR), information value-based priority handling between overlapping resources of one UE, and information value based PHY layer functions processing (e.g. channel coding, modulation, antenna and resource mapping).

The UE may perform, on a packet, any of the ULL functions described herein as a function of the information value of the packet, or as a function of the information value of the packet and a configuration received by the UE for processing the packet in ULL.

The UE may perform, on a packet, any of the MLL functions described herein as a function of the information value of the packet, or as a function of the information value of the packet and a configuration received by the UE for processing the packet in MLL.

The UE may perform, on a packet, any of the LLL functions described herein as a function of the information value of the packet, or as a function of the information value of the packet and a configuration for processing the packet in LLL.

Certain new or modified functions of the transport layer or XaaS Management/Control plane may equally apply for the first architecture embodiment and the second architecture embodiment. Examples include AQM/Buffer Management/Congestion control, QoE/QoS utility model and Overall L2 perspective

For AQM/Buffer Management/Congestion control, in any protocol layer/function described herein, packets may be placed in a buffer/queue for processing (e.g. congestion control, scheduling, routing, discard, etc.) as a function of a packet information value. For example, buffers/queues may be allocated as logical buffers/queues as a function of the information value (e.g. a first packet with a first impact to QoE is placed in a first logical buffer/queue, a second packet with a second impact to QoE is placed in a second logical buffer/queue, the first impact being different from the second impact and the first logical buffer/queue being different from the second logical buffer/queue). Alternatively, packets may be stored with their respective information value (e.g., upon data first becoming available for L2 processing) or packets may be processed according to specific events to determine (e.g., upon data first becoming available for transmission) and/or update their respective information value (e.g., upon inclusion of a related data amount in uplink control information e.g., in a BSR, D-SR or reporting possibly including information value information, e.g., upon reception of a grant for a new transmission, e.g., upon transport block multiplexing).

For QoE/QoS utility model, both embodiments can provide support for the QoE/QoS utility model with exchange of configuration information between transmitter/source and receiver/destination to enable the use/activation/deactivation of a QoE/QoS utility model, support for varying QoE/QoS utility attributes/metrics for a QoE/QoS utility model, or vice versa, support for varying QoE/QoS utility attributes/metrics with varying QoE/QoS utility model, or vice-versa, support for varying packet information values for a QoE/QoS utility model, or vice versa, and support for varying packet information values with varying QoE/QoS utility models, or vice versa.

For the overall L2 perspective, both embodiments can provide support for the PHY layer that offers a service (TBS), and a function to extract data from L2—either bearer-wise, PDU set-wise or per PDU, while the UE can maintain a “rating” per amounts of data depending on the modelling, and the rating (IV) can be used to make new decisions in the L2 QoS functions.

When it comes to the configuration for Information Value-based packet treatment, the present principles provide different possibilities.

In an embodiment, the UE receives, e.g. via common control signaling and/or dedicated signaling, configuration information indicative of one or more of the following configuration aspects to support information value-based treatment.

A first aspect is attributes of utility function(s). The UE may for example be configured with one or more of the following attributes that may be used to determine the QoE utility function that, in turn, may be used by the UE when determining/evaluating information value of a packet and/or to select a packet treatment configuration. These attributes include connectivity attributes (e.g. data rate, bit error rate, and latency), computation attributes (e.g. computation accuracy, and computation efficiency), AI/ML attributes (e.g. inference capability, prediction/estimation accuracy, and semantic error rate), sensing attributes (e.g. age of information, jitter, and human perception of the communication experience), and energy consumption attributes (e.g. computation energy consumption, energy efficiency, transmit power consumption, and network energy consumption).

A second aspect is weights of attributes for utility functions which may qualify how critical an attribute is for a QoE utility. The UE may for example be configured with one or more sets of weights of attributes for utility functions, and with conditions and/or rules for selection of attributes and/or weights of attributes for utility functions as described herein. For example, for an Ambient Internet of Things (AIoT) device, the weight for energy consumption utility may be infinite (or nonzero value much larger than X, or 1 if e.g. weights are normalized within [0, 1] interval value range), for a device operating with a battery, the weight for energy consumption utility may be in a range [1 X] (or in the interval (0,1) if e.g. weights are normalized) based on UE category (and the NW can configure according to its energy target for the UE or the system), while for a device on AC the value of weight for energy consumption utility may be zero.

A third aspect is mapping between set of attributes and weights of attributes of a utility function to an application type (i.e. type of application). For example, there may be one-to-one or many-to-one mapping between sets of attributes and/or weights of attributes and the application type; in one instance, UE may be configured with one set of attributes and weights of attributes of a utility function for a first type of application. In another instance, UE may be configured with more than one sets of attributes and weights of attributes of a utility function for a first type of application. For example, UE may be configured with a default set of attributes and weights of attributes of a utility function for an application type.

A fourth aspect is conditions and/or rules for selection of attributes and/or weights of attributes of utility functions. For example, the UE may be configured with one or more sets of attributes and/or weights of attributes of a utility function and be configured to select a set of attributes and/or weights of the attributes as a function of one or more of type of application, type of communication, modality of information etc., state of UE, and channel state or conditions.

For the type of application, type of communication, modality of information etc., e.g. the UE may be configured to select/use a first set of attributes and first set of weights of attributes for a first type of application, and the UE may be further configured to select/use a second set of attributes and second set of weights of attributes for a second type of application. The first type of application and the second type of application can be different. In one example, the first set of attributes and the first set of weights of attributes are different from the second set of attributes and the second set of weights of attributes. In another example, the first set of attributes and the first set of weights of attributes are the same as the second set of attributes and the second set of weights of attributes.

For the state of UE, the state may for example be operational status of the device, resource status, e.g. relative to a specific QoE metric (normalized nominal, normalized actual, e.g. remaining normalized computing resource level, normalized battery level), fulfillment of a KPI with respect to QoE or a specific QoE metric, context (e.g. location), mobility state (e.g. high, medium or low/normal mobility state), device state with respect to channel condition (e.g. channel state information), and application usage (e.g. active applications). The UE may be configured with a one-to-one or one-to-many mapping between sets of attributes and/or weights of attributes and the state of UE. For instance, the UE may be configured to select/use a first set of attributes and a first set of weights of attributes for a first state of UE. The UE may be further configured to select/use a second set of attributes and a second set of weights of attributes for a second state of UE. The first state of UE and the second state of UE can be different. In one example, the first set of attributes and the first set of weights of attributes are different from the second set of attributes and the second set of weights of attributes. In another example, the first set of attributes and the first set of weights of attributes are the same as the second set of attributes and the second set of weights of attributes.

For channel state or conditions, the UE may be configured with a mapping between sets of attributes and/or weights of attributes and one or more thresholds on channel conditions. For instance, the UE may be configured to select/use a first set of attributes and a first set of weights of attributes if channel conditions are above a first threshold value. The UE may be further configured to select/use a second set of attributes and a second set of weights of attributes if channel conditions are below a first threshold value. The first set of attributes and/or weights of attributes can be different from the second set of attributes and/or weights of attributes.

A fifth aspect is one or more configurations for one or more protocol functions, e.g. flexible packet coding (FPC) configuration, one or more LCP procedures, error correction through ARQ or HARQ, LDPC, AI/ML models and parameters etc.

A sixth aspect is default configuration of a protocol function. The UE may be configured with a default configuration of one or more protocol functions for a type of application, type of service, type of data, for a packet with IV below a threshold etc.

A seventh aspect is a function, e.g. lookup table (LUT), which maps a packet information value to a protocol layer configuration. For example, a first IV is mapped to a first configuration of PDCP functions such as header compression, ciphering or integrity protection, duplication, discard, in-order delivery or out-of-order delivery etc. and a second IV is mapped to a second configuration of PDCP functions such as header compression, ciphering or integrity protection, duplication, discard, in-order delivery or out-of-order delivery etc., wherein the first IV and second IV are different, and the first configuration of PDCP and second configuration of PDCP are different. For example, a first IV is mapped to a first RLC configuration e.g. RLC AM, RLC segmentation, a first packet coding method e.g. network coding configuration etc. For example, a second IV is mapped to a second RLC configuration e.g. RLC UM, RLC non-segmentation, a second packet coding method e.g. network coding configuration etc.

An eighth aspect is one or more allowed target QoE KPI ranges for one or more QoE metrics/utility functions, e.g. for the UE to consider when evaluating IV and/or treatment options for a packet, for one or more applications such as computing processing efficiency target KPI range (e.g. minimum computing processing delay requirement to minimize age-of-information, maximum computing delay requirement to avoid age-of-information exceeding a maximum value (e.g. the age after which information becomes useless)), response time (e.g. time consumed to generate response to a prompt), end-to-end latency or latency bounds, frame transmission rate (e.g. minimum and/or maximum number of application layer frames transmitted in a unit of time to support a minimum and/or maximum level of video resolution), and error rate (e.g. frame error rate, semantic error rate, bit error rate) for an application to operate at a target accuracy level (e.g. for inference task, AI/ML model training, AI/ML model update).

A ninth aspect is one or more conditions to trigger measurement and/or other assistance information reporting. The UE may be configured with one or more threshold values on application usage (e.g. number of applications), radio measurements, change in device state and/or capability, a specific QoE metric etc. to trigger a measurement and/or other assistance information reporting. Conditions to trigger reporting may be based on device state. For example, the UE may be configured with a first set of one or more conditions to trigger measurement and/or other assistance information reporting when UE is in a first state, configured with a second set of one or more conditions to trigger measurement and/or other assistance information reporting when UE is in a second state, wherein the first set of conditions and the second set of conditions are different; and the first UE state and the second UE state are different.

A tenth aspect is resources and/or protocol configurations to control QoS parameters/performance metrics and/or utility/score of utility attributes which may impact the QoE utility. These can include radio resources (e.g. radio bearers, frequency domain resources) to impact the QoS parameters such as data rate, frame rate, error rate, and latency, computing resources to use e.g. for computing efficiency, semantic knowledge bases (KBs) (the UE may be configured with one or more semantic knowledge bases with different levels of efficacy, i.e. accuracy and efficiency, wherein accuracy measures the semantic similarity between the generated content and the desired result, and efficiency quantifies the cost of deploying a semantic KB, including processing latency, energy consumption, storage resources, etc., and the UE may be configured to use a semantic KB for semantic communication based on a target QoE KPI such as inference accuracy, and computation efficiency (delay)), and information sources (e.g. the UE may be configured to use different information sources such as sensors to achieve different levels of scores for QoE utility in immersive applications etc.).

In an embodiment, the UE may receive dynamic/real-time control signaling to configure mapping of packets to network treatments options. For example, the UE may be configured with MLLs and LLLs through RRC for as many as planned QoS/QoE granularities for a UE (distinct information values), and mapping between information values and MLLs or LLLs may be controlled dynamically through MAC CE or DCI. The UE may also be configured with one or more configuration of protocol functions in a first group of functions, second group of functions, third group of functions, fourth group of functions, fifth group of functions, sixth group of functions, seventh group of functions through RRC, and mapping between information values and protocol function configuration may be controlled dynamically through MAC CE or DCI.

In an embodiment, the UE may receive semi-static control signaling to configure mapping of packets to network treatments options. The UE may be configured with MLLs and LLLs through RRC for as many as planned QoS/QoE granularities for a UE (distinct information values), and mapping between information values and MLLs or LLLs may be controlled via RRC configuration/re-configuration. The UE may also be configured with one or more configuration of protocol functions in a first group of functions, second group of functions, third group of functions, fourth group of functions, fifth group of functions, sixth group of functions, seventh group of functions through RRC, and mapping between information values and protocol function configurations may be controlled via RRC.

When it comes to UE measurements and other assistance information, the UE can report measurements (e.g. data volume, variable/dynamic device capabilities, radio environment etc.) and/or other assistance information such as application requirements, static device capabilities e.g. energy consumption efficiency, connectivity capabilities, computation efficiency capability, AI/ML capabilities etc. to provide assistance information to the network.

As mentioned, the UE can report measurements, for example to request resources for pending XaaS. In a design of conventional systems, for connectivity services, resources are requested in time, frequency, power domain, the resources are requested in terms of “why,” i.e. the UE reports data volume in the buffer and channel conditions which trigger the NW to allocate time-frequency domain and transmit power resources to the UE. In an alternative design of conventional systems, the UE requests the actual (or required) amount of resources in terms of time, frequency, power metrics, i.e. the UE requests resources in terms of “what”.

To meet XaaS requirements, e.g. for energy consumption, storage capacity, computation capability etc., resources may be requested in dimensions other than time-frequency, power domain. Therefore, conventional Buffer Status Reporting (BSR), Delay Status Reporting (DSR), Scheduling Requests (SR) may be enhanced to accommodate request for resources in different dimensions as described herein. UE may request resources in terms of “why” and/or “what” as described herein.

In an embodiment, the UE reports measurement of required computing resources, energy resources, storage resources etc., for example, for a pending service or a pending task.

In an embodiment, the UE reports the pending task to the network for network to allocate required resources. There UE may be pre-configured with an association between a task and resources required for the task.

In an embodiment, the UE reports to the network (e.g. base station) one or more of one or more indications or measurements of variable/dynamic device capabilities (such as remaining battery level, available/remaining computing processing power (e.g. number of central processing units (CPUs), cache memory of a CPU, number of graphics processing units (GPUs) or neural processing units (NPUs), and number of Tensor processing units (TPUs)), energy consumed within a certain time, available energy source type (e.g. renewable energy source, and fossil energy), remaining/available data storage capacity, and remaining transmission power), device state information (e.g. one or more of range of device states, current device state, wherein a state may be for example current operational status of the device, resource status (e.g. relative to a specific QoE metric (such as normalized nominal, normalized actual (e.g. remaining normalized computing resource level, normalized battery level)), buffer status report including device state with respect to buffer status (e.g. number of packets waiting for acknowledgement for a certain time etc.), for example, that the device is in a first state with respect to buffer status in case a number of packets waiting for acknowledgement for a certain time is greater than a first value, for example, that the device is in a second state with respect to buffer status in case number of packets waiting for acknowledgement for a certain time is greater than a second value), fulfillment of a KPI with respect to QoE utility or a specific QoE metric, context (e.g. location, environment), mobility state (e.g. high, medium or low/normal mobility state), cell-level measurements including device state with respect to a channel condition (e.g. channel state information (CSI), for example, the device is in a first state with respect to the channel condition in case CSI is higher than a first value, for example, the device is in a second state with respect to the channel condition in case CSI is higher than a second value), and application usage (e.g. active applications).

The UE can also report other assistance information to the network (e.g. base station) for example in reference to QoE or resource metrics described in Table 2 or in the description of FIG. 3. This assistance information can include one or more of one or more static device capabilities (for example, the UE may report energy capacity i.e. an indication of the maximum amount of energy the device can store or release (e.g. Ah, Wh, kWh), wherein a device may be categorized in energy capacity class wherein the class indicate the energy capacity of the device, the UE may report energy consumption efficiency capability (e.g. number of bis/joule/Hz, number of watts/gflops, ratio of renewable energy (e.g. harvested energy) to energy capacity or total energy consumption, ratio of carbon emission to energy consumption, energy consumption per specific operation/task), the UE may report maximum transmission power (e.g. device power class as an indication of number of dBm/W or number of dBm/mW), the UE may report computation capabilities (e.g. number of floating-point operations per second (FLOPS), computing resources (such as number and/or version of CPUs, GPUs, NPU, TPU etc.)), the UE may report maximum storage capacity i.e. total amount of data the device can hold, the UE may report storage efficiency (such as raw capacity versus usable capacity (e.g. in MB or GB), data access time, read/write and speeds), the UE may report data representation capabilities (e.g. binary data, real values, and semantic representation), the UE may report connectivity capabilities (such as supported error correction encoding/decoding techniques, packet erasures correction encoding/decoding techniques, modulation schemes, number of transmit antennas, and supported HARQ mechanisms), the UE may report sensing capabilities (such as sensing resolution, number and/or types of sensors), the UE may report supported codecs (such as number and/or types of codecs), the UE may report security, privacy and safety capabilities (such as supported data encryption algorithms, and dynamic security configuration update capability)), AI/ML capabilities (the UE may report supported AI/ML model algorithms, data and parameters for different applications, services or network operation), application requirements, for example target QoE KPI ranges for one or more QoE metrics for one or more applications such as energy consumption efficiency target KPI (e.g. energy efficiency requirement for the application to operate to user's satisfaction e.g. without device overheat), computing processing efficiency target KPI (such as computing processing delay requirement for an application e.g. to minimize age-of-information, and response time to a prompt), response time (e.g. time consumed to generate response to a user prompt), end-to-end latency or latency bounds, frame transmission rate (e.g. minimum and/or maximum number of application layer frames transmitted in a unit of time to support a minimum and/or maximum level of video resolution), and error rate (e.g. frame error rate, semantic error rate, bit error rate etc. for an application to operate at a target accuracy level e.g. for inference task, AI/ML model training, and AI/ML model update).

Measurements and other assistance information can be reported in different manners that can be used in parallel.

Reporting can be triggered by a configured condition. In an embodiment, the UE triggers reporting of one or more measurements and/or other assistance information in case one or more conditions are satisfied. These conditions include a change in device state (for example, the UE may trigger reporting if there is a change in device state such as a change in application usage such as a number of active applications being equal to or above a configured threshold), a change in mobility state (for example, the UE may be configured with a first mobility state and a second mobility state, and be further configured to trigger a report for measurement and/or other assistance information in case the mobility state changes from a first mobility state to a second mobility state or vice versa; for example, the UE may be configured to trigger a report for measurement and/or other assistance information in case a change in UE speed is more than a pre-configured threshold value), activation of an application/service, de-activation of an application/service, a change in device state with respect to channel conditions, a level of fulfillment of a KPI with respect to QoE or a specific QoE metric (for example, the UE may be configured to trigger a report for measurement and/or other assistance information in case a level of fulfillment of a KPI with respect to QoE or a specific QoE metric is below or above a pre-configured threshold value), heat dissipation in the device is equal or above a threshold value, a change in dynamic/variable device capability (for example, storage capacity is above or below a threshold value, battery level is above or below a threshold value, and remaining computing resource level is below or above a threshold value)), arrival of data of one or more services (for example, arrival of data of a certain application/service, arrival of data of two or more services, and arrival of data of a certain group of services), arrival of one or more packets with a new or specific information value (for example, arrival of a packet with a new or specific information value, and a number of arrived packets, with a specific information value, being above a configured threshold value), a change in context (e.g. location of the UE), a change in channel state or conditions (for example, the UE triggers reporting if radio measurements (e.g. SNR, SNIR, RSRP etc.) go above or below a threshold value, the UE triggers reporting if a proxy measurement for channel condition goes above or below a threshold value (e.g. a consecutive number of HARQ feedback failures (NACK, DTX, etc.) or a consecutive number of ARQ failures (e.g., RLC NACK) goes above a threshold value), the UE triggers reporting in case there is a change in state of the radio/channel (such as from a first RLM state to a second RLM state)), determination that at least a certain data volume is above a certain threshold value for a specific IV value, and determination that the information value for one or more packets is of a specific IV value (possibly, for a first packet currently in the UEs buffer, and for a second packet currently in the UEs buffer).

The UE may also perform periodic reporting of measurements and/or other assistance information. The UE may be configured to report one or more measurements, device state information, other assistance information, periodically (e.g. based on a pre-configured timer), to assist network in scheduling decisions and providing configurations to the UE to support one or more applications and services.

The UE may trigger reporting of one or more measurement, device state information, other assistance information, etc. upon reception of explicit information (for example using specific signaling) to send the report (i.e. the UE receives polling from the network to send the report). The UE may also trigger reporting of one or more measurement, device state information, other assistance information, etc. to the network upon reception of signaling for a control plane event (e.g. handover, RRC reconfiguration).

As for signaling to report measurements other assistance information, there are different approaches. In an embodiment, the UE sends the measurement and/or other assistance information report using an L1/L2/LLL/MLL control message. For example, the UE may transmit the report in UCI on a PUCCH resource, the UE may transmit the report in UCI on a PUSCH resource, or the UE may transmit the report in a MAC CE, L2/MLL control PDU.

Certain aspects of the QoE Utility Function will now be described.

The UE can determine the QoE utility function as a function of one or more connectivity attributes, computation attributes, AI/ML attributes, sensing attributes, energy consumption attributes etc., and the weights of the attributes of utility function. The UE can then use the QoE utility function when determining/evaluating the information value of a packet and/or to select a packet treatment configuration.

In an embodiment, the UE determines the QoE utility function as a function of one or more of the following attributes and/or weights of attributes: connectivity attributes (e.g.: data rate (e.g. bit rate, semantic rate), error rate (e.g. bit error rate, block error rate, frame error rate), latency, and semantic reliability), computation attributes (e.g. computation accuracy, and computation efficiency), AI/ML attributes (e.g. inference capability, prediction/estimation accuracy, semantic reduction degree, and semantic similarity), sensing attributes (e.g. age of information, jitter, and human perception of the communication experience), energy consumption attributes (e.g. computation energy consumption, energy efficiency (e.g. Joules/bit), transmit power consumption, and network energy consumption), and task completion rate.

The QoE utility function can be controlled by the NW. In an embodiment, the UE determines the utility function based on received signaling from the network which indicates one or more attributes of utility function and the corresponding weights of the attributes. For example, the UE may be configured with utility function attributes and weights per application, per use case, per service, etc. Specifically, the UE may be configured with a first set of attributes and a first set of weights of attributes for a first type of application (e.g. sensing) and a second set of attributes and a second set of weights of attributes for a second type of application (e.g. audio call). As another example, the UE may be configured with utility function attributes based on the type of communication the UE uses. Specifically, the UE may be configured with a first set of attributes and a first set of weights of attributes for first type of communication (e.g. semantic communication) and a second set of attributes and a second set of weights of attributes for a second type of communication (e.g. classical (non-semantic) communication). In another embodiment, the UE may be pre-configured with a model (e.g. standardized model) and may receive parameters of the model from the network to determine the QoE utility function. In an example, the parameters may be UE specific (i.e. applicable for all UE states, channel states, applications, services etc.). In another example, the parameters may be indicated or configured per UE state, per channel state, per application, per service, etc.

The QoE utility function can be determined autonomously by the UE. In an embodiment, the UE determines the attributes of utility function, and the corresponding weights of the attributes based on one or more of channel state or conditions (for example, the UE may determine the QoE utility function as a function of a first set of attributes and/or weights of attributes in case channel conditions are above (or below) a first threshold value, the UE may determine the QoE utility function as a function of a second set of attributes and/or weights of attributes in case channel conditions are above (or below) a second threshold value, wherein the first set of attributes and/or weights of attributes and the second set of attributes and/or weights of attributes are different), UE state (for example, the UE may determine the QoE utility function as a function of a first set of attributes and/or weights of attributes in case UE is in a first state (e.g. based on operational status of the device, or application usage (e.g. active applications)), the UE may determine the QoE utility function as a function of a second set of attributes and/or weights of attributes in case the UE is in a second state, wherein the first set of attributes and/or weights of attributes and the second set of attributes and/or weights of attributes can be different, and wherein the first UE state and the second UE state can be different), feedback from the network (for example, the UE may determine at a first time instant that the QoE utility function is based on a first set of attributes and/or weights of attributes (e.g. based on received signaling from the network), the UE may determine to update utility function based on a second set of attributes and/or weights of attributes at a second time instant based on feedback received from the network related to fulfillment of a KPI with respect to QoE or a specific QoE metric; for instance, the UE may determine that the QoE utility function for video transmission is based on data rate and UE transmit power

$$( such as U = 0.5 * \frac{transmit data rate}{target data rate} + 0.5 * ( 1 - \frac{used transmit power}{Max . transmit power} ) )$$

at the start of video data transmission, the UE may receive feedback from NW indicating poor quality of received video and may determine to update the QoE utility function as function of data rate, reliability and transmit power

$$( such as U = 0.7 * \frac{transmit data rate}{target data rate} + 0.1 * ( 1 - \frac{used transmit power}{Max . transmit power} ) + 0.2 * reliability ) )$$

for further video data transmission.

The packet Information Value (IV) can be determined (for example by the UE) in different ways. The IV of a packet can be based on one or more of indication from higher layers, metadata in packet, characteristics of information (e.g. age of information (AoI), and semantic richness) in a packet, and impact of packet on a QoE utility. The IV can for example be an integer, an identifier or index in a table of information values, or an enumeration.

In an embodiment, the UE determines the IV of a packet based on one or more of packet characteristics and/or indication(s) in the packet header such as an indication in the packet information header (e.g. from application-level API) (for example, the UE receives an indication of the IV of a packet in an information header e.g. from application-level API) associated with one or more packets), type of packet (for example, the UE may be pre-configured with an association between types of packet and packet information values, where the type of packet for example may be based on the content of packet and may be of an enumeration type or quantized values from a configured range, where there may be a one-to-one or many-to-one mapping between type of packet and IV; in one instance, the UE maps a first type of packet to a first IV and a second type of packet to a second IV, wherein the first type of packet and the second type of packet are different, and the first IV and the second IV are different; in another instance, the UE maps a first type of packet to a first IV, a second type of packet to a first IV, where the first type of packet and the second type of packet are different), Age of Information (AoI) (for example, the UE may determine the IV based on the AoI of the packet, where the AoI may have discrete values (e.g. in units of time) or qualitative values (e.g. high, medium, low), where there may be a one-to-one or many-to-one mapping between the AoI and the IV; in one instance, the UE maps a first value of the AoI to a first IV and a second AoI value may be mapped to a second IV, wherein the first AoI value and the second AoI value are different, and the first IV and the second IV are different; in another instance, the UE maps a first AoI value to a first IV, maps a second AoI value to a first IV, where the first AoI value and the second AoI value are different), source of information (for example, the UE may be pre-configured with a one-to-one or many-to-one mapping between the source of information of packet and packet IV; in one instance, the UE may determine that a first packet carrying information from a first source (e.g. a first sensor) has a first IV and a second packet carrying information from a second source (e.g. a second sensor) has a second IV, where the first source of information and the second source of information are different and where the first IV and the second IV are different; in another instance, the UE may determine that a first packet carrying information from a first source has a first IV and a second packet carrying information from a second source has a first IV, where the first source of information and second source of information are different; the UE may determine the IV of packet from an information source based on the state of source, for example, the UE may determine that a first packet carrying information from a first source in a first state has a first IV and a second packet carrying information from a second source in a second state has a second IV, where the first IV and the second IV are different, and the first state of source and the second state of source are different), semantic richness of a packet (for example, the UE may be pre-configured with a mapping between the semantic richness of a packet and packet IV, and may determine that a first packet with an amount of semantic information below a first threshold value has a first IV and a second packet with an amount of semantic information below a second threshold has a second IV, where the first threshold and the second threshold are different, and the first IV and the second IV are different; for example, the UE may autonomously determine the IV of a packet relative to other packets in a PDU set, set of packets, data burst, QoS flow etc.; in one instance, the UE determines that a packet with more semantic richness than other packets have a higher IV as compared to other packets, and a packet with less semantic richness than other packets is determined to have lower IV as compared to other packets, where levels of information value may be determined based on discrete levels of semantic richness of packets in a PDU set, a set of packets, a data burst, a QoS flow etc.; in another instance, the UE determines that a packet with a semantic richness more than or equal to average semantic richness of packets has a high IV and that a packet with a semantic richness less than or equal to average semantic richness of packets has lower IV), size of a packet (for example, the UE may be pre-configured with a mapping between packet size and packet IV and the UE may determine that a first packet of a first size or a size below a first threshold value has a first IV and a second packet of a second size or a size below a second threshold value has a second IV, where the first size or threshold and the second size or threshold are different and the first IV and the second IV are different; for example, the UE may autonomously determine the IV of a packet relative to other packets in a set of packets, a data burst, a QoS flow etc.; in one instance, the UE determines that a packet with larger size than other packets have a higher IV compared to other packets, a first packet with a size smaller than a second packet is determined to have a lower IV compared to the second packet, a third packet with a size larger than the second packet is determined to have a higher IV compared to the second packet, where levels of IV may be determined based on a distinct number of sizes of packets in a set of packets, a data burst, a QoS flow etc.; in another instance, the UE determines that a packet with a size more than or equal to an average of sizes of packets has a high IV and that a packet with size less than or equal to average of sizes of packets has a low IV), rate of change of observation (for example, the UE may be pre-configured with a mapping between a rate of change of observation (e.g. in haptic communications) and the IV of a packet with haptic data, the UE may determine that a first packet with haptic data from a source with a rate of change of observation above or below a first threshold value has a first IV and a second packet with haptic data from a source with a rate of change of observation above or below a second threshold value has a second IV, where the first threshold and second threshold are different and the first IV and second IV are different), change of observation (for example, the UE may be pre-configured with a mapping between change of observation as compared to previously transmitted observation (e.g. in sensing applications) and the IV of a packet with sensing data, the UE may determine that a first packet with sensing data representing an observation with a change of observation, compared to a previously transmitted observation, above (or below) a first threshold value has a first IV and a second packet with sensing data representing an observation with a change of observation, compared to a previously transmitted observation, above (or below) a second threshold value has a second IV, where the first threshold and the second threshold are different and the first IV and second IV are different; for example, the UE may autonomously determine the IV of a packet relative to other packets in a PDU set, a set of packets, a data burst, a QoS flow etc., the UE can determine that a first packet with more change in observation than a second packet has a higher IV compared to a second packet, and a third packet with less change in observation than the second packet can be determined to have a lower IV compared to the second packet), feedback from the network (for example, the UE receives feedback from a receiver about the contribution of a transmitted first packet (e.g. with specific characteristics such as information source, size, and modality of data) to the QoE utility function, and the UE uses the received feedback to update the IV of a second packet that has the same characteristics as the first packet; for example, the UE receives feedback from the network to explicitly indicate the IV of a first packet (e.g. with specific characteristics such as information source, size, modality of data) and uses the received packet IV to update the information value of a second packet that has the same characteristics as the first packet), level of contribution of data toward recovering the source information (for example, when flexible packet coding (FPC) such as network coding (NC) is used, the UE can determine that a first packet that is an innovative NC coded packet has a high IV and a second packet that is non-innovative NC coded packet has a low IV; for example, when flexible packet coding (FPC) such as network coding (NC) is used, the UE can determine that a first packet that is a systematic packet has a high IV and a second packet that is non-systematic packet has a low IV; for example, when the UE processes NC coded packets for transmission, it can determine that a first NC coded packet that has a first level of innovativeness has a first IV and a second NC coded packet that has a second level of innovativeness has a second IV, where the first level of innovativeness and the second level of innovativeness are different, and the first IV and the second IV are different; for example, when the UE processes NC coded packets for transmission, it can determine that a first NC coded packet that has a first level of innovativeness and a second NC coded packet that has second level of innovativeness have a first IV, where the first level of innovativeness and the second level of innovativeness are different; for example, in a video transmission using layered video coding, the UE can determine that a first packet from the base layer has a first IV (e.g. high information value) and a second packet from an enhancement layer has a second IV (e.g. high information value), where the first IV and second IV are different, type of application/service (e.g. safety critical, industrial control, sensory, video, voice, AI/ML model training) (the UE may be pre-configured with a one-to-one or many-to-one mapping between the type of application/service to which a packet belongs and the packet IV; in one instance, the UE determines that a first packet associated with a first application/service has a first IV and a second packet associated with a second application/service has a second IV, where the first application/service and the second application/service are different, and the first IV and the second IV are different; in another instance, the UE may determine that a first packet that is associated with a first application/service has a first IV and a second packet that is associated with a second application/service has a first IV, where the first application/service and the second application/service are different, type of the data (i.e. information carried in the packet—e.g. text, image, and AI/ML model parameters) (for example, the UE may be pre-configured with a one-to-one or many-to-one mapping between the type of data in the packet and the packet IV; in one instance, the UE may determine that a first packet carrying data of a first type has a first IV and a second packet carrying data of a second type has a second IV, where the first type of data and the second type of data are different and the first IV and second IV are different; in another instance, the UE may determine that a first packet carrying data of a first type has a first IV and a second packet carrying data of a second type has a first IV, where the first type of data and second type of data are different), modality of the data (e.g. vision, smell, touch) (for example, the UE may be pre-configured with a one-to-one or many-to-one mapping between modality of data in the packet and packet IV; in one instance, the UE may determine that a first packet carrying data associated with a first modality has a first IV and a second packet carrying data associated with a second modality has a second IV, where the first modality and second modality are different and the first IV and the second IV are different; in another instance, the UE may determine that a first packet carrying data associated with a first modality has a first IV and a second packet carrying data associated with a second modality has a first IV, where the first modality and second modality are different), and impact on QoE utility (for example, the UE may determine the IV of a packet based on the expected impact of processing and transmission of the packet on a QoE utility metric (e.g. frame rate, energy consumption); the UE may determine that a first packet that requires a first amount of energy consumption for processing and transmission has a first IV and a second packet that requires a second amount of energy consumption for processing and transmission has a second IV, where the first amount of energy consumption and the second amount of energy consumption are different; for example, the UE may determine the IV of a packet based on the expected impact of processing and transmission of the packet on a QoE utility KPI target and/or one or more target QoE metrics (e.g. video resolution, energy consumption budget); for example, the UE may determine that a first packet that requires a first amount of energy consumption for processing and transmission would cause the total energy consumption (e.g. within a certain time) to exceed an energy consumption budget, that a second packet that requires a second amount of energy consumption for processing and transmission would not exceed the energy consumption budget, and may assign a first IV (e.g. low/bad) to the first packet and a second IV (e.g. high/good) to the second packet).

In an embodiment, the UE determines the IV of a packet based on metadata in a packet. The UE can be configured with a standardized metadata set and a mapping between metadata and IV for one or more QoE utility function target KPIs. In case the UE detects first metadata in a first packet, it can determine that the first packet has a first IV and in case the UE detects second metadata in a second packet, it can determine that the packet has a second IV, where the first metadata is different from the second metadata and the second IV is different from the first IV.

In an embodiment, the UE determines the packet IV using a pre-configured function (e.g. an AI/ML model) that can predict/estimate the impact of processing and transmission of a packet on QoE utility function and determines the IV of the packet. The IV of a first packet may be determined in one of the protocol layers and the UE may use this information value to determine the protocol configuration for treatment of the first packet in next protocol layers in the processing path. The UE may determine a first IV of a first packet in one protocol layer, e.g. in a first protocol layer, and use this first IV to map the first packet to the next protocol layer, e.g. a second protocol layer, in the processing path. The UE may further determine a second IV of the first packet in the second protocol layer and determine the protocol configuration of the second protocol layer as a function of the second IV and the capability of the protocol configuration to support the second IV.

In an embodiment, the UE selects a QoE metric/utility function target KPI (e.g. from the range configured by the network) as a function of one or more of device state (as already described), channel conditions, feedback (e.g. from the network) and configurations received from the network. For example, the UE may be configured with a one-to-one or one-to-many mapping between QoE metric/utility function target KPI and device state, the UE may select a first target KPI for a QoE metric when the UE is in a first device state, and a second target KPI for a QoE metric when the UE is in a second device state, where the first device state and the second device state are different, the first target KPI and the second target KPI can be different, or they can be the same. For example, the UE may be configured with a one-to-one or one-to-many mapping between QoE metric/utility function target KPI and channel conditions (e.g. channel state, radio measurements etc.), may select a first target KPI for a QoE metric when the channel is in a first state, select a second target KPI for a QoE metric when the channel is in a second state, where the first channel state and the second channel state are different, and the first target KPI and the second target KPI are different, or they can be the same. For example, the UE may select a first KPI target for a QoE metric at a first time instant, may receive feedback from the network (e.g. indicating allowed QoE target KPI), may select a second KPI target for the QoE metric at a second time instant, wherein the second KPI target may be the same as allowed QoE target KPI indicated by the network.

Information Value (IV) based packet treatment will now be described in further detail. The intention is to describe how to perform information value-based packet classification and marking, ciphering and integrity protection, how the UE performs data flow prioritization and allocation of bits to a resource grant (e.g. including restriction of information value mapping) in an information value-based packet treatment framework, how to control and manage UE buffers in an information value-based packet treatment framework, how to perform energy/computing/storage resource constraint-based packet discard, how to perform information value-based packet routing, error control (e.g. packet erasure, bit error), and how to dynamically/real-time adapt protocol behaviors as a function of variable QoE utility target KPIs in an information value-based packet treatment framework.

The UE can perform packet classification and marking as a function of the IV of the packet. In an embodiment, the UE (e.g. in PDU layer, in ULL, in new data plane upper layer) performs packet classification and marking as a function of at least an IV of the packet, i.e. the UE uses IV-based QoS rule and Packet Detection Rules (PDR), wherein a QoS rule includes a QoS Flow Identifier (QFI) of the associated QoS flow, and at least a packet filter set wherein the packet filter set includes at least one IV of the associated packets. For example, the UE can detect a first packet of a first IV, and a second packet of a second IV, where the first IV and the second IV are different. The UE can mark (i.e., associate) the first packet with the first IV, and the second packet with the second IV. The UE can associate UL packets with QoS flows as a function of packet IV and QoS rules. For example, the UE may associate a first packet of a first IV with a first QoS Flow, a second packet of a second IV with a second QoS Flow, where the first packet information value and the second information value are different, and the first QoS flow and the second QoS flow are different. For example, the UE may associate a first packet of a first IV to a first QoS Flow, a second packet of a second IV to a first QoS Flow, where the first IV and the second IV are different.

The UE can submit packets to lower layers together with their IVs. In an embodiment, the UE maps a packet from upper layers to a lower layer as a function of the packet IV and the lower layer configuration, e.g. capability of the lower layer to support the information value of the packet. The UE includes in the header of a packet from an upper layer, the IV of the packet, an index or an ID of the IV of the packet. For example, the UE (e.g. in SDAP) maps a packet from upper layers (e.g. PDU layer, in-RAN data plane application) to a DRB as a function of the packet IV and the DRB configuration, e.g. capability of the DRB to support the IV of the packet. The mapping to DRB may be one-to-one or many-to-one; for example, the UE can include a first IV in the header of a first packet, and a second IV in the header of a second packet; the UE can include a first IV in the header of a first packet, and a second IV in the header of a second packet. UE further includes third information value in the header of the first packet, and a fourth information value in the header of the second packet. The third and fourth IVs may be importance/priority or supplemental information values of the first packet and the second packet respectively. The UE may map a first packet of a first IV to a first DRB, and a second packet of a second IV to a second DRB, where the first IV and the second IV are different, and the first DRB and the second DRB are different. The UE may map a first packet of a first IV to a first DRB, and a second packet of a second IV to a first DRB, where the first information value and the second information value are different.

For in-QoS-flow differentiated treatment, in an embodiment, the UE performs in-QoS-flow differentiated treatment of a packet belonging to a DRB as a function of the packet IV and the configuration of the lower layers (e.g. capability of a lower layer to support the information value of a packet).

The UE may perform on a packet, any of the PDCP functions described herein as a function of the IV of the packet.

For example, the UE may perform one or more of header compression, ciphering or integrity protection, duplication, discard, in-order delivery or out-of-order delivery on a first packet as a function of a first IV. The UE can perform one or more of header compression, ciphering or integrity protection, duplication, discard, in-order delivery or out-of-order delivery on a second packet as a function of a second IV, the first information value being different from the second information value. For example, the UE uses the IV of a packet as an input to ciphering or integrity protection algorithm to cipher or integrity protect the packet. For example, in case the processing/transmission of a first packet would cause an energy consumption to go above an energy consumption budget threshold (i.e. the IV is bad/negative for quality of experience) and the processing/transmission of a second packet would cause an energy consumption to remain below an energy consumption budget threshold (i.e. the IV of the second packet is good/positive), the UE can drop the first packet. The UE can perform, using a first configuration, one or more of header compression, ciphering or integrity protection, duplication, discard, in-order delivery or out-of-order delivery on a first packet as a function of a first IV and the first configuration, perform, using a second configuration, one or more of header compression, ciphering or integrity protection, duplication, discard, in-order delivery or out-of-order delivery on a second packet as a function of a second IV, where the first configuration is different from the second configuration, and the first IV is different from the second IV. The UE can be configured with a first ciphering algorithm, and a second ciphering algorithm, cipher a first packet of a first IV with the first ciphering algorithm, cipher a second packet of a second IV with the second algorithm, where the first IV is different from the second IV, and the first algorithm is different from the second algorithm.

For example, the UE may be configured with a first configuration for a first lower layer (e.g. a first RLC configuration e.g. RLC AM, RLC segmentation, a first packet coding method e.g. network coding configuration) of a first DRB, and a second configuration for a second lower layer (e.g. a second RLC configuration e.g. RLC UM, RLC non-segmentation, a second packet coding method e.g. network coding configuration) of a first DRB. A first packet of a DRB has a first IV, a second packet of a first DRB has a second IV, where the first IV and the second IV are different. The UE (e.g. in PDCP) can route the first packet to a first lower layer as a function of the first IV and the first configuration, and the second packet to a second lower layer as a function of the second IV and the second configuration.

For example, a DRB may configured with one or more logical channels. A first packet of a first logical channel has a first IV and a second packet of the first logical channel has a second IV, where the first IV and the second IV are different. The UE can apply a first treatment to the first packet as a function of the first IV, and apply a second treatment to the second packet as a function of the second IV, where the first treatment (e.g. error protection, scheduling (e.g. prioritization, prioritized rate), MCS, power allocation, antenna and resource mapping, etc.) and the second treatment are different.

The UE can perform protocol processing function as function of information value in different ways. The UE may perform, on a packet, any of the protocol processing functions described herein as a function of the IV of the packet, or as a function of the IV of the packet and a configuration received by the UE for processing the packet in the said protocol function.

For example, the UE receives a first configuration for processing packet of the first IV, and a second configuration for processing packet of a second IV, receives a first packet of a first IV and a second packet of a second IV, where the first IV is different from the second IV.

The first configuration can configure the UE with RLC segmentation, the second configuration with no RLC segmentation, and the UE can perform segmentation or re-segmentation of a packet as a function of the packet information value, i.e. only for the first packet.

The first configuration can configure the UE with packet erasure correction through ARQ, and the second configuration with packet erasure correction through packet coding (e.g. linear packet coding, network coding, etc.). The UE can perform packet erasure correction through ARQ on the first packet, and packet erasure correction through packet coding on the second packet.

The first configuration can configure the UE with packet erasure correction through packet duplication, and the second configuration with packet erasure correction through packet coding (e.g. linear packet coding, network coding, etc.) The UE can perform packet erasure correction through packet duplication on the first packet, and packet erasure correction through packet coding on the second packet

The first configuration can configure the UE to map packets of the first IV to a first transport channel (service access point to PHY) and packets of the second IV to a second transport channel. The UE can map the first packet to the first transport channel and the second packet to the second transport channel.

The first configuration can configure the UE to route packets of the first IV to a first logical channel/logical buffer, and packet of the second IV to a second logical channel/logical buffer, the first logical channel/logical buffer being different from the second logical channel/logical buffer. The first logical channel/logical buffer and the second logical channel/logical buffer are associated with the same RLC. The UE can route the first packet to the first logical channel and the second packet to the second logical channel.

The first configuration can configure the UE with a first property of scheduling information for the scheduling of packets of the first IV. The second configuration configures the UE with a second property of scheduling information for the scheduling of packets of the second IV. The first configuration and the second configuration may be the same configuration or different configurations. The UE can use the first property of scheduling information to schedule the first packet and the second property of scheduling information to schedule the second packet. The UE can respect a first “packet IV mapping restriction to a resource grant/grant type” for the scheduling of the first packet, and a second “packet IV mapping restriction to a resource grant” for the scheduling of the second packet, wherein the first property of scheduling information is the first “packet IV mapping restriction to a resource grant/grant type”, and the second property of scheduling information is the second “packet IV mapping restriction to a resource grant”. The UE can prioritize allocation of the first packet or part of the first packet to a first resource grant, and allocation of the second packet or part of the second packet to a second resource grant, wherein the first property of scheduling information is the first resource grant, and the second property of scheduling information is the second resource grant. The first configuration can configure the UE with a first resource grant for scheduling of the first packet or part of the first packet, the second configuration can configure the UE with a second resource grant for scheduling of the second packet or part of the second packet, where the first resource grant and the second resource grant are overlapping resource grants, and the UE prioritizes the transmission of the first packet or part of the first packet, where the first property of scheduling information is the first resource grant, and the second property of scheduling information is the second resource grant.

The first configuration can configure the UE with an association of packets of the first IV to a first logical channel/logical buffer, and packets of the second IV to a second logical channel/logical buffer, the first logical channel/logical buffer and the second logical/logical buffer being the same. The UE can use the first property of scheduling information to schedule the first packet and the second property of scheduling information to schedule the second packet.

As already described with reference to FIG. 4, in an embodiment, the UE applies a protocol configuration for packet treatment to one or more packets according to a configuration associated with one or more attributes beyond connectivity attributes or connectivity QoS requirements of the packets. These attributes may be associated with e.g. computing efficiency, storage and/or energy cost etc. The protocol configuration for packet treatment may for example include ciphering, prioritization, data multiplexing, and data discard.

The UE receives information indicative of one or more protocol configurations for packet treatment (e.g. for ciphering or integrity protection, error protection, data multiplexing), information indicative of one or more configuration for determination of packet information value of a packet (e.g. association between packet characteristics and packet information value), information indicative of one or more configuration for association between protocol configuration and packet information value, and information indicative of configuration for evaluation of QoE utility wherein QoE utility may be a function of one or more attributes e.g. energy and/or storage cost, computing efficiency, inference accuracy etc. The UE is configured with received configurations.

The UE receives data packets for transmission in its buffer, determines the respective packet characteristics, for example based on the content of the packet (e.g. heading), the size of the packet, identifiers associated with the packets and indicated in a header or via the application, and determines the packet IV based on at least the characteristics determined and its configurations.

The UE selects a protocol configuration for treatment of the received packet according to the determined packet information value and one or more of the received configurations.

The UE processes the data packets according to the selected protocol configuration.

The UE transmits the processed data packets.

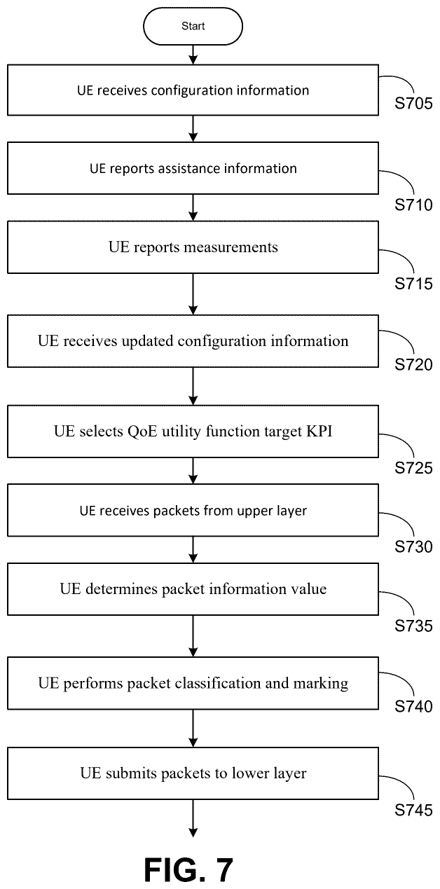

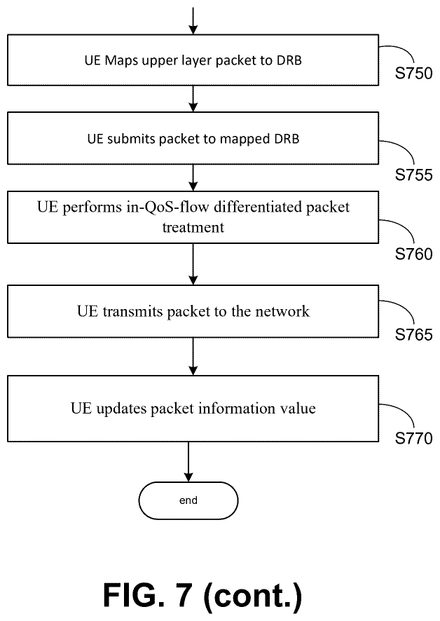

FIG. 7 illustrates a method according to a further embodiment of the present principles. Briefly speaking, the UE determines a packet information value (IV) as a function of one or more of indication from higher layers, metadata in packet, characteristics of information (e.g. age of information, semantic richness etc.) in a packet, impact of the packet on a QoE utility (that may be a function of one or more of energy consumption efficiency metric, connectivity performance metric, computation efficiency metric, AI/ML efficiency metric, sensing efficiency metric, storage efficiency metric, safety, security and privacy) etc., performs packet classification and marking as a function of at least an IV of the packet, maps a packet from a protocol layer to a lower protocol layer as a function of the packet IV or the packet marking and the lower layer configuration (e.g. a capability of the lower layer to support the IV of the packet), processes the packet in the lower layer as a function of the packet IV and the lower layer configuration. Put another way, the UE may augment a treatment function with a cost function that is a function of attributes, beyond QoS requirements of a connectivity service, such as computing, storage and/or energy cost that may be parametrized (or bounded) by a QoS range that satisfies the QoE of a service and related elasticity requirement.

In step S705, the UE receives from the network, information indicative of one or more configurations related to attributes of utility function(s) (e.g. connectivity attributes (e.g. data rate, bit error rate, latency), computation attributes (e.g. accuracy, efficiency), AI/ML attributes (e.g. inference capability, prediction/estimation accuracy, semantic error rate), sensing attributes (e.g. age of information, jitter, human perception of the communication experience), and energy consumption attributes (e.g. computation energy consumption, energy efficiency, transmit power consumption, network energy consumption)), weight(s) of attribute(s) for utility function(s), one or more allowed target QoE KPI ranges for one or more QoE metrics/utility functions for one or more applications, radio resources (e.g. radio bearers, frequency domain resources), computing resources to use, semantic knowledge base, information sources, configurations of protocol layers (e.g. flexible packet coding (FPC) configuration, LCP procedures, error correction through ARQ or HARQ, LDPC, AI/ML models and parameters for one or more protocol layer functions), a function, e.g. lookup table (LUT), which maps a packet information value to a protocol layer configuration (e.g. a first IV is mapped to a first RLC configuration (e.g. RLC AM), RLC segmentation, a first packet coding method (e.g. network coding configuration), e.g. a second IV is mapped to a second RLC configuration (e.g. RLC UM), RLC non-segmentation, a second packet coding method (e.g. network coding configuration)), and a default configuration of a protocol layer (e.g. for a type of application, type of service, type of data, for packet IV below a threshold).

In step S710, the UE reports to the network (e.g. base station) one or more items of assistance information, for example in reference to QoE or resource metrics described in Table 2 or with reference to FIG. 3. The item(s) of assistance information can include device capabilities (for example one or more of static capabilities (e.g. energy capacity i.e. an indication of the maximum amount of energy the device can store or release (e.g. Ah, Wh, kWh), where a device may be categorized in energy capacity class wherein the class indicate the energy capacity of the device, energy consumption efficiency capability (e.g. number of bis/joule/Hz, number of watts/gflops, ratio of renewable energy (e.g. harvested energy) to energy capacity or total energy consumption, ratio of carbon emission to energy consumption, energy consumption per specific operation/task), maximum transmission power (e.g. device power class as an indication of number of dBm/W or number of dBm/mW), computation capabilities (e.g. number of floating-point operations per second (FLOPS), computing resources (such as number and/or version of CPUs, GPUs, NPU, TPU etc.)), storage capacity (i.e. amount of data the device can hold), storage efficiency, data representation capabilities (e.g. binary data, real values), connectivity capabilities, supported codecs, and security, privacy and safety capabilities), and one or more variable/dynamic device capabilities (e.g. battery level, processing power (nominal, actual)), where any of one or more of these capabilities may also be reported by the UE as variable/dynamic capability), application requirements (e.g. target QoE KPI ranges for one or more QoE metrics (see Table 2) for one or more applications (such as energy consumption efficiency target KPI (e.g. energy efficiency requirement for the application to operate to the user's satisfaction (e.g. without device overheat)), computing processing efficiency target KPI, response time (e.g. time consumed to generate response to a user prompt), end-to-end latency or latency bounds, and frame transmission rate), device state information (e.g. one or more of range of device states, current device state), where a state for example may be current operational status of the device, resource status (e.g. relative to a specific QoE metric (normalized nominal, normalized actual (e.g. remaining normalized computing resource level), normalized battery level), fulfillment of a KPI with respect to QoE or a specific QoE metric, context e.g. location, mobility state (e.g. high, medium or low/normal mobility state), cell-level measurements including device state with respect to channel condition (e.g. channel state information), application usage (e.g. active applications)), and supported AI/ML model algorithms, data and parameters for different applications or network operation.

In step S715, the UE reports measurements (e.g. data volume, radio environment/channel conditions, update to device state) to the network.

In step S720, the UE receives from the network information indicative of an updated configuration such as attributes of utility function, weights of attributes, configuration for assistance information reporting, and one or more allowed target QoE KPI ranges for one or more QoE metrics/utility functions for one or more applications.

In step S725, the UE selects a QoE utility function target KPI, from the range received in step S710 (e.g. as a function of one or more of device state, channel conditions, feedback from the network). For example, different QoE levels such as high, medium, low (corresponding to e.g. first frame rate, second frame rate, third frame rate, respectively) may be configured for a video service. The UE may target high QoE, i.e. first frame rate (mapped to e.g. 15 Mb/s), at a first time when it is in a first state (e.g. running a first number of applications). The UE may select a medium target KPI, i.e. the second rate (mapped to e.g. 10 Mb/s), at a second time when it is in second state (e.g. running second number of applications). Different QoE levels, such as high, medium, low (for example corresponding to 15 Mb/s, 10 Mb/s, 5 Mb/s data rates, respectively), may be configured for a video service and the UE may target high QoE, i.e. 15 Mb/s, at a first time when channel conditions are above a first threshold value and the UE may select medium target KPI at a second time when channel conditions are below a first threshold value.

In step S730, the UE receives one or more packets from upper layer.

In step S735, the UE determines the information value (e.g. an integer, identifier or index in a table of information values, enumeration etc.) of a received packet.

The UE can determine the IV as a function of one or more of an indication in packet information header (e.g. from application-level API), age of information, source of information, semantic richness (amount of semantic information) of a packet, size of a packet, rate of change of observation (e.g. haptic information with larger gradient with respect to previous information has higher information value, feedback from the network (e.g. see step S770), level of contribution of data toward recovering the source information (e.g. when NC is used, innovative packets have higher IV than non-innovative packets; e.g. in layered video coding, packets from the base layer have higher IV than packets from enhancement layers), type of application/service (e.g. safety critical, industrial control, sensory, video, voice, AI/ML model training), and type or modality of the data (i.e. information carried in the packet) (e.g. vision, haptics (smell, touch etc.), text, AI/ML model parameters).

The UE can be configured with a standardized metadata set and a mapping between metadata and information value for one or more QoE utility function target KPIs. If the UE detects first metadata in a packet, it determines that the packet has a first IV and if the UE detects second metadata in a packet, it determines that the packet has a second IV, where the first metadata is different from the second metadata and the second information value is different from the first information value.

The UE can determine the packet IV using an AI/ML model that can determine the packet information value as a function of the predicted/estimated impact of processing and transmission of the packet on a utility (e.g. energy consumption, data rate).

In step S740, the UE (e.g. in the PDU layer, new data plane upper layer) performs packet classification and marking as a function of at least an IV of the packet. The UE uses IV-based QoS rule and Packet Detection Rules (PDR).

For example, the UE detects a first packet of a first IV, and a second packet of a second IV, the first IV and the second IV are different, marks (i.e., associates) the first packet with the first IV, and the second packet with the second IV, and maps a packet to QoS flow as a function of the packet IV.

IV mapping to QoS flow may be one-to-one or many-to-one. For example, the UE maps a first packet of a first IV to a first QoS Flow, maps a second packet of a second IV to a second QoS Flow, where the first packet IV and second IV are different and the first QoS flow and the second QoS flow are different. For example, the UE maps a first packet of a first IV to a first QoS Flow, maps a second packet of a second IV to a first QoS Flow, where the first IV and the second IV are different.

In step S745, the UE submits packets from upper layers together with their IVs to lower layers (e.g. SDAP).

In step S750, the UE (e.g. in SDAP) maps a packet from upper layers to a DRB as a function of the packet IV (instead of QoS Flow ID) and the DRB configuration (e.g. capability of the DRB to support the information value of the packet).

The mapping to DRB may be one-to-one or many-to-one. For example, the UE can include a first IV in the header of a first packet, and a second IV in the header of a second packet. For example, the UE can map a first packet of a first IV to a first DRB, and a second packet of a second IV to a second DRB, where the first IV and the second IV are different, and the first DRB and the second DRB are different. For example, the UE can map a first packet of a first IV to a first DRB, and a second packet of a second IV to a first DRB, where the first IV and the second IV are different.

In step S755, the UE submits a packet to a DRB (e.g. PDCP) to which the packet is mapped.

In step S760, the UE performs in-QoS-flow differentiated treatment of a packet belonging to a DRB as a function of the packet IV and configuration of the lower layers (e.g. capability of a lower layer to support the information value of a packet).

The UE can be configured with one or more DRBs. As a first example, the UE is configured with a first configuration for a first lower layer (e.g. a first RLC configuration e.g. RLC AM, RLC segmentation, a first packet coding method e.g. network coding configuration) of a first DRB, and a second configuration for a second lower layer (e.g. a second RLC configuration e.g. RLC UM, RLC non-segmentation, a second packet coding method e.g. network coding configuration) of a first DRB. A first packet of a DRB has a first IV and a second packet of a first DRB has a second IV, where the first IV and the second IV are different. The UE (e.g. in PDCP) routes the first packet to a first lower layer as a function of the first IV and the first configuration, and the second packet to a second lower layer as a function of the second IV and the second configuration. As a second example, a DRB is configured with one or more logical channels. A first packet of a first logical channel has a first IV and a second packet of the first logical channel has a second IV, where the first IV and the second IV are different. The UE applies a first treatment to the first packet as a function of the first IV, applies a second treatment to the second packet as a function of the second IV, where the first treatment (e.g. error protection, scheduling (e.g. prioritization, prioritized rate), MCS, power allocation, antenna and resource mapping, etc.) and the second treatment are different.

In step S765, the UE transmits one or more packets to the network.

In step S770, the UE updates information value of a packet. For example, the UE receives feedback from network about contribution of a first transmitted packet to the QoE utility function. UE uses the received feedback to update the IV of a second packet. For example, the UE updates the IV of a packet according to a new IV, received from the network, of a first transmitted packet.

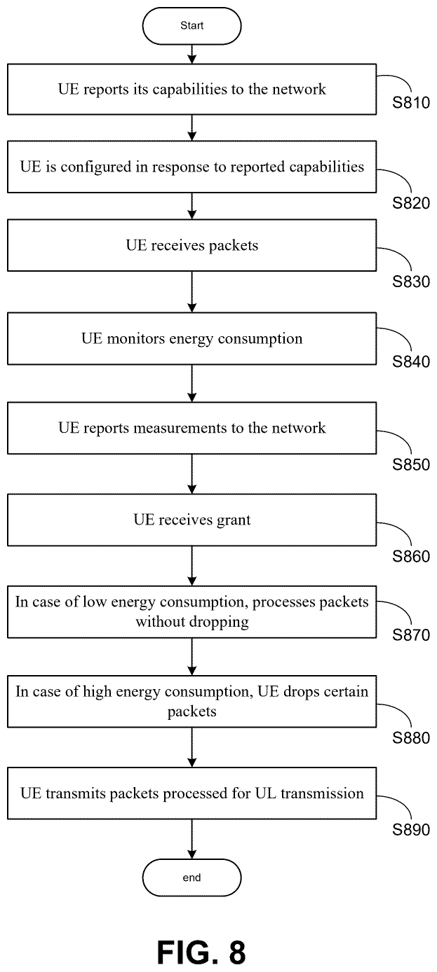

FIG. 8 illustrates a method according to a further embodiment of the present principles.

In step S810, the UE reports its capabilities to the network (e.g. base station). These capabilities can be energy-related and include one or more of energy capacity (i.e. an indication of the maximum amount of energy the UE can store or release), energy consumption efficiency capability, and maximum transmission power (e.g. device power class as an indication of number of dBm/W or number of dBm/mW).

In step S820, the UE is configured in response to reported capabilities. The UE can be configured with one or more of energy consumption budget (e.g. for XR application) per specific time period, mapping between modality/type of data in a packet and packet information value (IV) (e.g. packet from base layer of layered video coding has a first IV (e.g. high IV), e.g. packet from enhancement layer of layered video coding has a second IV (e.g. low IV), e.g. audio packet has a third information value (e.g. medium information value)), mapping between packet IV and configurations of protocol layers (i.e. associated treatment for packet processing and transmission), and weights for attributes (i.e. video resolution, audio quality and device energy consumption) for utility function (e.g. for XR application),

$$( e . g . for U = 0.5 * video resolution + 0.3 * audio rate + 0.2 * ( 1 - \frac{energy consumption}{energy budget ( Δ t )} )$$

where energy budget(Δt) is the energy consumption budget for a time period Δt.

In step S830, the UE receives packets for a XR multimodal traffic (i.e. audio and video packets) for uplink transmission. The UE determines the respective IV of received packets as a function of the mapping between modality/type of data in a packet and packet IV.

In step S840, the UE tracks/monitors energy consumption (e.g. total energy consumed by the UE for processing and transmitting packets for all data flows of the XR traffic) per unit of time.

In step S850, the UE reports measurements to the network (e.g. base station), for example including one or more data volumes in its buffer and possible energy consumption for each data volume, resource status (e.g. remaining energy level (e.g. battery level), remaining energy consumption relative to the energy consumption budget in a specific time period), and channel conditions.

In step S860, the UE receives a grant in response to the reported measurements.

In step S870, in case the monitored energy consumption is below a pre-configured threshold value in the pre-configured time period, the UE processes packets with first, second and third information value for UL transmission based on the mapping between packet information value and configurations of protocol layers.

In step S880, in case the monitored energy consumption reaches a pre-configured threshold in the pre-configured time period, the UE updates the weights of utility function attributes (e.g. reduces the weight of video resolution, increases the weight for energy consumption, e.g. the UE updates utility function as

$$U = 0.3 * video resolution + 0.3 * audio rate + 0.4 * ( 1 - \frac{energy consumption}{energy budget ( Δ t )} ) ,$$

determines the IV of packet as a function of its impact on updated utility function (e.g. the UE determines that a packet from the base layer of layered video coding has a first IV (e.g. high IV), a packet from an enhancement layer of layered video coding has a fourth IV (e.g. zero IV), and an audio packet has a third IV (e.g. medium IV)), processes packets with the first and third IV for UL transmission based on the mapping between packet IV and configurations of protocol layers, and drops packets with fourth IV from processing for UL transmission.

In step S890, the UE transmits the packets that it has processed for UL transmission.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency trade-offs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method at a wireless transmit/receive unit, WTRU, in a network, the method comprising:
receiving from the network a grant for uplink transmission;
receiving a data packet;
determining at least one characteristic of the data packet;
determining, based on the at least one characteristic of the data packet, a value indicative of possible energy consumption associated with transfer of the data packet; and
based on the value indicative of possible energy consumption associated with transfer of the data packet and a given energy budget value, transmitting the data packet to the network using the uplink grant or dropping the data packet.

2. The method of claim 1, further comprising:
transmitting, to the network, information indicative of energy-related capabilities of the WTRU; and
implementing a configuration based on the transmitted information.

3. The method of claim 2, wherein the energy-related capabilities comprise at least one of energy capacity, energy consumption efficiency capability, and maximum transmission power.

4. The method of claim 2, wherein the configuration comprises at least one of energy consumption budget per specific time period, a mapping between modality or type of data in a packet and value indicative of possible energy consumption associated with transfer of the data packet, a mapping between value indicative of possible energy consumption associated with transfer of the data packet and configurations of protocol layers, and attributes and/or weights for attributes for a utility function.

5. The method of claim 4, wherein the value indicative of possible energy consumption associated with transfer of the data packet is determined as a function of the mapping between the modality or type of data in the data packet and the value indicative of possible energy consumption associated with transfer of the data packet.

6. The method of claim 1, further comprising:
monitoring energy consumption.

7. The method of claim 6, wherein the energy consumption is monitored for a given time period.

8. The method of claim 6, wherein the data packet is transmitted to the network in case the monitored energy consumption is below a configured value in a given time period.

9. The method of claim 6, wherein the data packet is dropped in case the monitored energy consumption is above a configured value.

10. A wireless transmit/receive unit, WTRU, comprising at least one processor configured to:
receive from a network a grant for uplink transmission;
receive a data packet;
determine at least one characteristic of the data packet;
determine, based on the at least one characteristic of the data packet, a value indicative of possible energy consumption associated with transfer of the data packet; and
based on the value indicative of possible energy consumption associated with transfer of the data packet and a given energy budget value, transmit the data packet to the network using the uplink grant or drop the data packet.

11. The WTRU of claim 10, wherein the at least one processor is configured to:
transmit, to the network, information indicative of energy-related capabilities of the WTRU; and
implement a configuration based on the transmitted information.

12. The WTRU of claim 11, wherein the energy-related capabilities comprise at least one of energy capacity, energy consumption efficiency capability, and maximum transmission power.

13. The WTRU of claim 11, wherein the configuration comprises at least one of energy consumption budget per specific time period, a mapping between modality or type of data in a packet and a value indicative of possible energy consumption associated with transfer of the data packet, a mapping between value indicative of possible energy consumption associated with transfer of the data packet and configurations of protocol layers, and attributes and/or weights for attributes for a utility function.

14. The WTRU of claim 13, wherein the at least one processor is configured to:
determine the value indicative of possible energy consumption associated with transfer of the data packet as a function of the mapping between modality or type of data in the data packet and the value indicative of possible energy consumption associated with transfer of the data packet.

15. The WTRU of claim 10, wherein the at least one processor is configured to:
monitor energy consumption.

16. The WTRU of claim 15, wherein the at least one processor is configured to:
monitor the energy consumption for a given time period.

17. The WTRU of claim 15, wherein the at least one processor is configured to:
transmit the data packet to the network in case the monitored energy consumption is below a configured value in a given time period.

18. The WTRU of claim 15, wherein the at least one processor is configured to:
drop the data packet in case the monitored energy consumption is above a configured value.
